(19) United States
(12) Patent Application Publication
(10) Pub. No.: US 2011/0066549 A1
(43) Pub. Date: Mar. 17, 2011

(54) SYSTEM AND METHOD TO PROVIDE CUSTOMS HARMONIZATION, TARIFF COMPUTATIONS, AND CENTRALIZED TARIFF COLLECTION FOR INTERNATIONAL SHIPPERS

(75) Inventor: Harry T. WHITEHOUSE, Portola Valley, CA (US)

(73) Assignee: PSI SYSTEMS, INC., Palo Alto, CA (US)

(21) Appl. No.: 12/857,446

(22) Filed: Aug. 16, 2010

Related U.S. Application Data
(60) Provisional application No. 61/234,126, filed on Aug. 14, 2009.

(51) Int. Cl. G06Q 50/00; G06F 17/00; G06Q 40/00

(52) U.S. Cl. 705/39; 705/408; 705/402; 705/401; 705/331; 235/375

(57) ABSTRACT

The systems and methods described herein relate generally to the integration of a shipping label with a customs form to provide a single label having postage, addressing, customs, and other information for international shipping, and in particular, to managing landed cost and harmonization for international packages. In one embodiment, managing the landed cost and harmonization may comprise generating a unique self-validating postage indicium or mark in response to a request that includes a description of contents for a package onto which an international shipping label is to be placed and a destination country where the package is to be delivered. As such, the unique self-validating postage indicium or mark may indicate that landed costs for delivering the package to the destination country have been pre-paid, wherein the unique self-validating postage indicium or mark and a customs declaration form may be printed on the international shipping label.

### CROSS REFERENCE TO RELATED APPLICATIONS

The present Patent Application is based on and claims priority to U.S. Provisional Patent Application No. 61/234,126 filed on Aug. 14, 2009, the entire content of which is hereby incorporated by reference.

### FIELD OF THE INVENTION

The systems and methods described herein generally relate to integrating an international shipping label with a customs form to provide a shipping label having postage, addressing, customs, and other information for international shipping, and in particular, to computing and managing landed cost and harmonization for international packages. Landed cost is defined herein as the end cost of an internationally shipped item. The cost includes purchase price, freight, insurance, and other costs and may sometimes include duties, tariffs and taxes.

### BACKGROUND OF THE INVENTION

The current procedure for preparing an international package for shipping involves a number of time-consuming steps. First, the shipping label must be generated. The typical minimum amount of information is the destination address and the sender's address. Secondly, some form of United States (“US”) postage must be affixed to the package. This could be conventional stamps, a postage meter strip from a conventional meter, a postage validation imprinter (“PVI”) postage strip issued by a US Post Office, or digital Information Based Indicia postage (“IBI” or “PC postage”). Online postage was first described in U.S. Pat. No. 5,319,562 to Whitehouse, filed Aug. 22, 1991. A subsequent patent, U.S. Pat. No. 6,005,945 to Whitehouse, filed Mar. 20, 1997, described an extension of the online postage concept—a centralized postage system premised on Web or Telephonic Milli-Transactions. Both of these patents are hereby incorporated by reference in their entirety.

Thirdly, the US Postal Service (“USPS”), along with the Universal Postal Union (“UPU”) and the World Customs Organization (“WCO”), has historically required a separate and distinct customs declaration form, which must be affixed to the package. One of the simplest customs and declaration forms 10 is the PS 2976 (alternately referred to as the CN22), a representative diagram of which is shown in FIG. 1. The form 10 repeats the sender 20 and recipient 30 address information, and adds details 40 as to the contents of the package including value and classification (e.g., Gift, Sample, Documents, Other). The newer forms, such as form 60 shown in FIG. 2, include a six digit Harmonization Tariff Schedule (“HTS”) export number, which represents the product to the origin country (e.g., U.S.) using an internationally-established classification system.

Form 60, referred to by USPS as PS 2976A (and also known as the CP72), is used for certain sub-classes of mail, or when package valuation exceeds $500. The data on form PS 2976A is virtually the same as that on form PS 2976 (e.g., contains sender information 70, recipient information 80, details of contents 90, etc.), but the form is provided with multiple copies (up to five) and the format is larger.

These conventional forms are time consuming to complete, and replicate much of the data on the shipping label itself. The forms must be properly matched with the shipping label and postage, which can be problematic in a high volume shipping environment.

The right hand side of the PS 2976 (CN22) form 10 is designed to be separated and archived at the USPS, which inducts the mail. The copy is stored in a manual filing system for thirty days and then discarded. In the case of form PS 2976A (e.g., form 60), one complete copy of the form 60 is held at the origin Post Office for thirty days. The purpose of this storage is to provide some record of the induction of the mail piece. But the storage protocol is archaic and very inefficient. If information is requested for a given package, the originating Post Office must first be determined, and a manual search of the hardcopy records must then be undertaken by USPS personnel at that Post Office. The information is only retained for thirty days, which in many cases is a shorter period of time than the overall delivery cycle, particularly in the case of surface international mail subclasses which are transported by boat.

Furthermore, in addition to the issues noted above, shipments of international packages often require the payment of taxes and duties associated with processing and delivering the international packages in a foreign country, wherein the shipper or recipient must pay the taxes and duties in addition to any postage that must be paid to postal authorities in the originating country. In many instances, both the shipper and the recipient of an international package may prefer to pre-pay these international taxes and duties, as the recipient need not be present to receive the package if the taxes and duties have been pre-paid, nor does the mailer have to pay additional money on delivery.

The USPS has expressed that there is increasing certain market pressure to provide the pre-payment option to shippers that have smaller volume because competing carriers such as FedEx and UPS allow taxes and duties to pre-paid for their customers, and further because of new rules that the Postal Regulatory Commission (“PRC”) has established for market dominant and competitive products, published at www.prc.gov/pre-docs/home/PAEA/FinalRulesWeb.pdf. Furthermore, shipment security rules may also drive the requirement to have shippers pre-pay the taxes and duties due on international packages.

### SUMMARY OF THE INVENTION

The systems and methods described herein generally relate to integrating an international shipping label with a customs form to provide a shipping label having postage, addressing, customs, and other information for international shipping, and in particular, to managing landed cost and harmonization for international packages.

In one embodiment, a method for managing landed cost and harmonization for international packages shipped within an international postal system may comprise receiving a request for an international shipping label, wherein the request may include at least a description of contents for a package onto which the international shipping label is to be placed and a destination country where the package is to be delivered. The method may further comprising generating a unique self-validating postage indicium in response to the request, wherein the unique self-validating postage indicium may indicate that landed costs for delivering the package containing the contents to the destination country have been pre-paid. Furthermore, the method may comprise enabling printing of the international shipping label having the unique self-validating postage indicium printed thereon, wherein the international shipping label may further include a customs declaration form that includes the description of the contents of the package onto which the international shipping label is to be placed.

In one embodiment, an online postage system may be configured to manage landed cost and harmonization for international packages shipped within an international postal system. In particular, the system may comprise, among other things, a postage-issuing computer system and a communications link connecting a user computer with the postage-issuing computer system. The postage-issuing computer system may be configured to receive a request for an international shipping label from the user computer. For example, the request may include at least a description of contents for a package onto which the international shipping label is to be placed and a destination country where the package is to be delivered. The postage-issuing computer system may then generate a unique self-validating postage indicium in response to the request received from the user computer, wherein the unique self-validating postage indicium may indicate that landed costs for delivering the package containing the contents to the destination country have been pre-paid. The postage-issuing computer system may then enable printing of the international shipping label having the unique self-validating postage indicium printed thereon, wherein the international shipping label may further include a customs declaration form that includes the description of the contents of the package onto which the international shipping label is to be placed.

Other systems, methods, features, and advantages of the invention will be apparent to those skilled in the art based on the following drawings and detailed description.

### BRIEF DESCRIPTION OF THE FIGURES

FIG. 1 illustrates an exemplary copy of the PS 2976 customs declaration form;

FIG. 2 illustrates an exemplary copy of the PS 2976A customs declaration form;

FIG. 3 illustrates an exemplary system diagram of an online postage system configured to electronically generate an integrated shipping label and customs form, according to one aspect of the invention;

FIGS. 4-7 illustrate exemplary embodiments of an integrated shipping label and customs form, according to one aspect of the invention;

FIGS. 8-16 illustrate exemplary embodiments of a user interface that can be used to electronically generate an integrated shipping label and customs form, according to one aspect of the invention;

FIGS. 17a and 17b illustrate exemplary embodiments of a user interface that can be used to generate and integrate shipping label and customs form and calculate shipping costs and taxes and duties using Harmonized Tariff Schedule (HTS) codes, according to one aspect of the invention;

FIG. 18 illustrates an exemplary process for managing landed cost and harmonization for international packages, according to one aspect of the invention;

FIG. 19 illustrates an exemplary system for managing landed cost and harmonization for international packages, according to one aspect of the invention;

FIG. 20 illustrates an exemplary process for authenticating refund requests on an integrated shipping label and customs form, according to one aspect of the invention;

FIG. 21 illustrates an exemplary process for paying tariffs on behalf of one or more shippers, according to one aspect of the invention; and

FIGS. 22A-22G depict various windows or graphical interfaces of the shipping software for generating an integrated shipping label and customs form displayed as a dialog windows, according to an embodiment of the present invention.

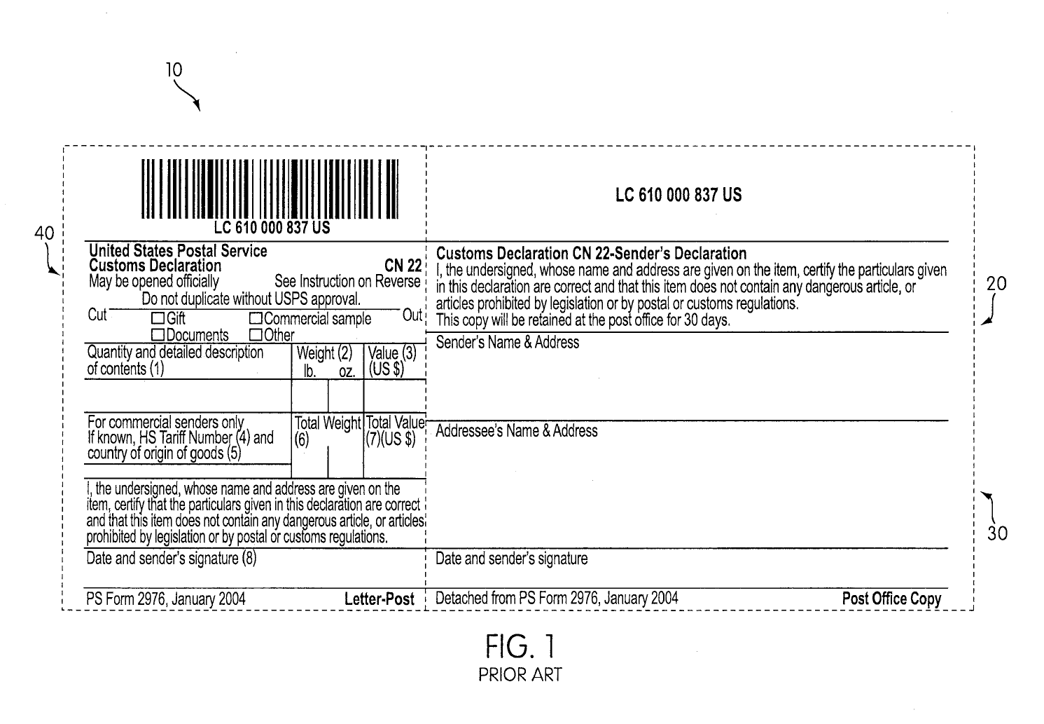

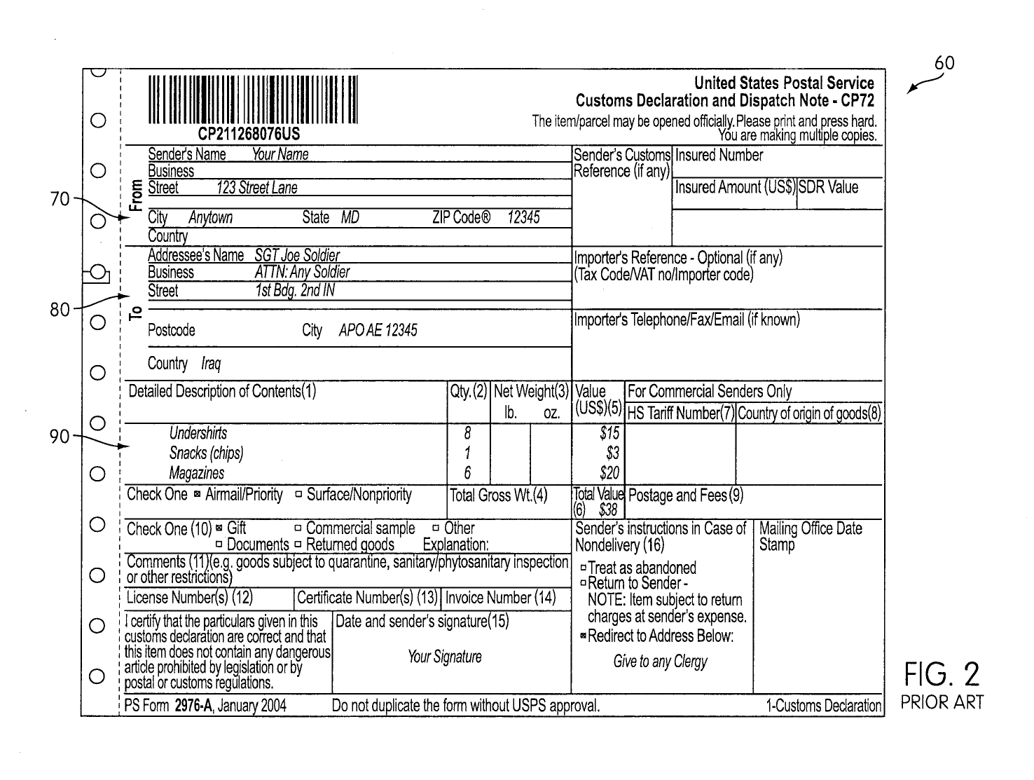

### DETAILED DESCRIPTION

The systems and methods described herein provide for an integrated shipping label having international shipping and customs information displayed thereon. The integrated shipping label can be used in place of the conventional shipping label and separate customs form used by a post service, such as the USPS. The integrated shipping label has a unique customs form number or other unique identifier displayed thereon (e.g., in a barcode format). The unique customs form number or other unique identifier may be unique within the postal service's system and can have any desired shipping and customs information for the package associated with it. Furthermore, the systems and methods allow for electronically storing data associated with each package shipment. The systems and methods allow for the management of a discount service on behalf of a postal service using a centralized online postage system.

In one embodiment, the systems and methods described herein can be used with the systems and methods described in U.S. Pat. No. 5,341,505, issued Aug. 23, 1994, U.S. Pat. No. 6,005,945, issued Dec. 21, 1999, U.S. Patent Application Pub. No. 2003/0101143, published May 29, 2003, U.S. Patent Application Pub. No. 2003/0101147 published May 29, 2003, and U.S. Patent Application Pub. No. 2003/0101148, published May 29, 2003, each of which are hereby incorporated by reference in their entirety. Each of these patents and published patent applications, at least in part, point out the value of using tracking (or delivery confirmation) numbers on domestic USPS shipments to reduce fraud and provide a refund methodology that accounts for misprints and other events outside of the user's control. These patents and published patent applications also set forth a centralized online postage system that can be used with the systems and methods described herein.

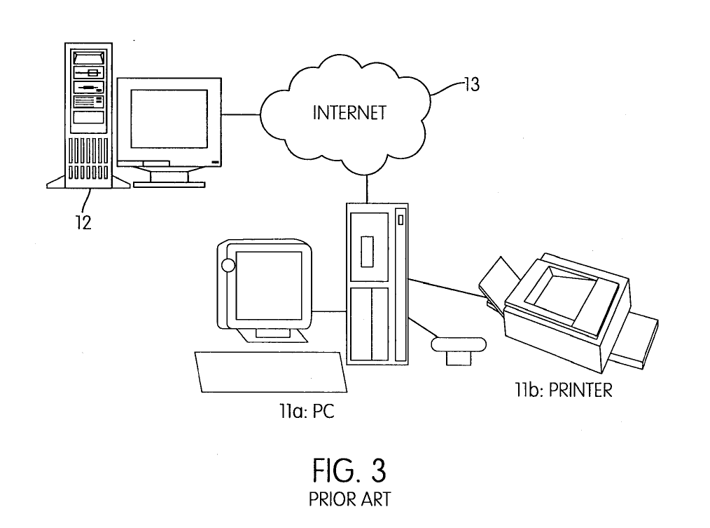

For example, turning to FIG. 3, a computer environment in which a user may purchase online postage is shown. A user at a personal computer (PC) 11a may connect to a server computer 12 configured to enable the user to electronically purchase valid postage, typically via an Internet-type network 13. The user may interact with a software program (e.g., DAZzle by Endicia) on the personal computer 11a, which may be downloaded from the server computer 12, installed on the personal computer 11a, and/or embedded in a Web page accessible via a Web browser, which may allow the user to manage postage purchases.

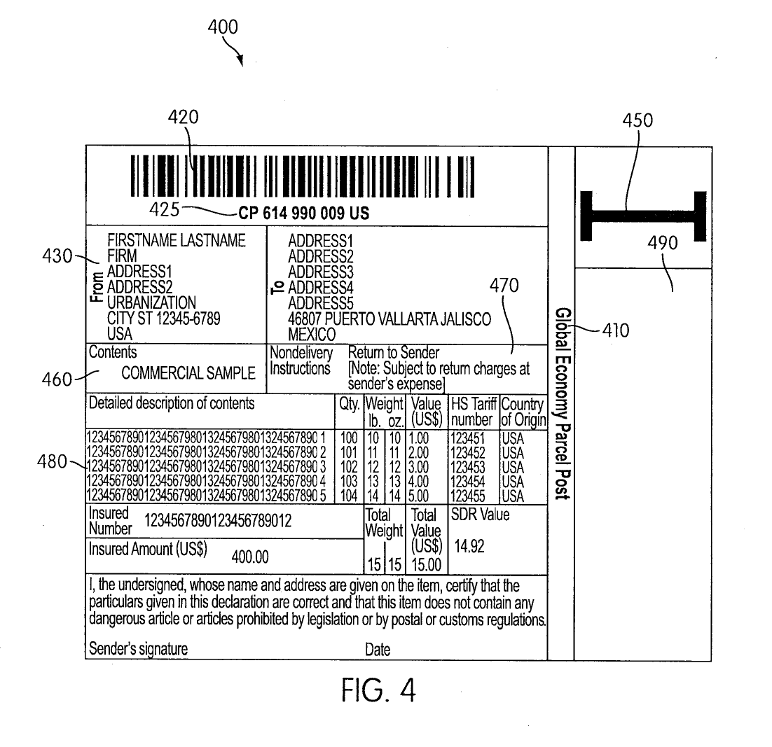

Turning to FIG. 4, the USPS has a general format for “universal” shipping labels, which are shipping labels for international shipments of US origin or destination that can be generated electronically. The shipping label 400 is generally about four by six inches in size, landscape style, and includes a large capital “I” 450, which typically has a serif font. Also included is content identification 460 (e.g., gift, document, commercial sample, etc.) and sender's instructions 470 (e.g., return to sender, abandon upon non-delivery, etc.). The label 400 can also include insurance information 480, such as insurance number and insured amount. A printout of the label 400 is preferably four-ply, with two copies provided for a customs declaration, one for a dispatch note, and one for a customer copy. An online label record may also be provided. The online record contains the customs number and can be used for confirmation of acceptance by the USPS. The record can also be used as the proof of mailing receipt for customers who bring their items to a Post Office for postage and acceptance, whereby a Post Office copy may no longer be required because the information can be stored in a database and retained for any suitable period of time (e.g., six months).

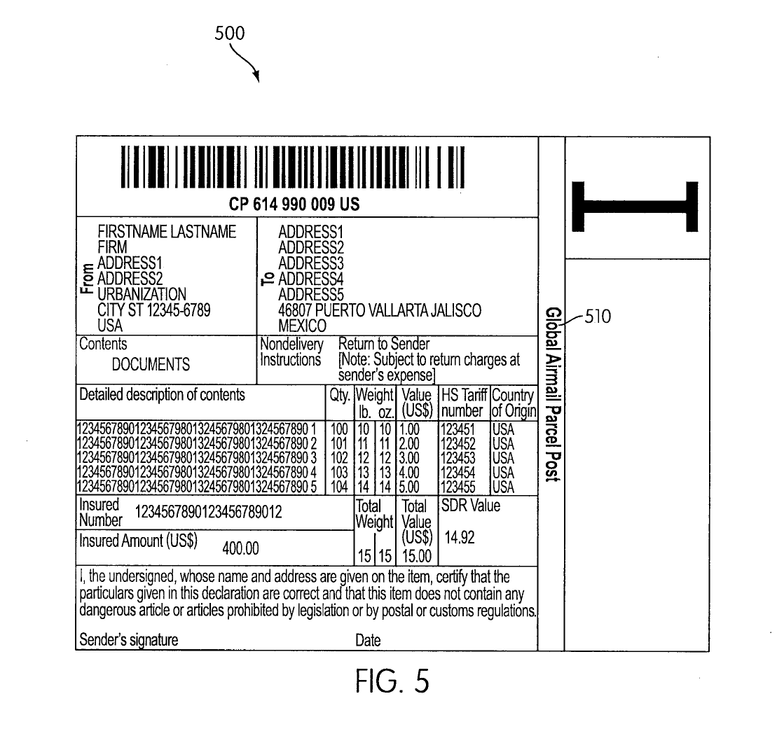

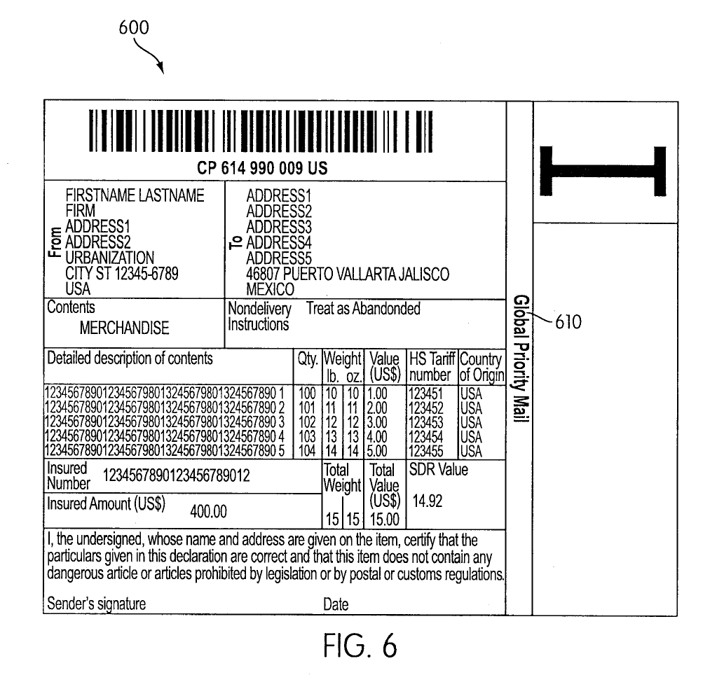

In one embodiment, the shipping label 400 may also provide a service type (e.g., Global Priority Mail, Global Airmail, Global Economy, etc.), wherein shipping labels corresponding to each of these service types are illustrated in FIGS. 4-6, respectively. In particular, FIG. 4 illustrates a shipping label 400 corresponding to Global Economy Parcel Post 410, FIG. 5 illustrates a shipping label 500 corresponding to Global Airmail Parcel Post 510, and FIG. 6 illustrates a shipping label 600 corresponding to Global Priority Mail 610.

In one embodiment, the shipping label 400 may further include a barcode 420, typically a Code U128 type barcode. The barcode 420 may appear above the address segment 430, as shown in FIG. 4, and may include a customs form tracking number (e.g., 2976A), which may uniquely identify the mail piece. In one embodiment, human readable numbers 425 may be provided below the barcode 420 to further uniquely identify the mail piece. The shipping label 400 may also include various graphics, which may be limited to a particular resolution such as two-hundred dots per inch (“dpi”), and the graphics can be provided in a graphic image file (“GIF”) format, a tagged image file (“TIF”) format, a portable document format (“PDF”), or any other suitable format.

In one embodiment, postage can be paid with postage stamps, postage meter stamps, PVI labels, permit imprints, or any other suitable mechanism. In one embodiment, the shipping label 400 may include a designated postage area 490 alongside the “I” 450, which may be reserved for placement of the postage. In addition, in one embodiment, the postage placed in the area 490 may include postage marks and/or indicia generated according to the techniques described in U.S. patent application Ser. No. 09/990,605, filed Nov. 20, 2001, U.S. Pat. Nos. 5,319,562 and 5,341,505, and/or the patents and published patent applications noted above, each of which are hereby incorporated by reference in their entirety.

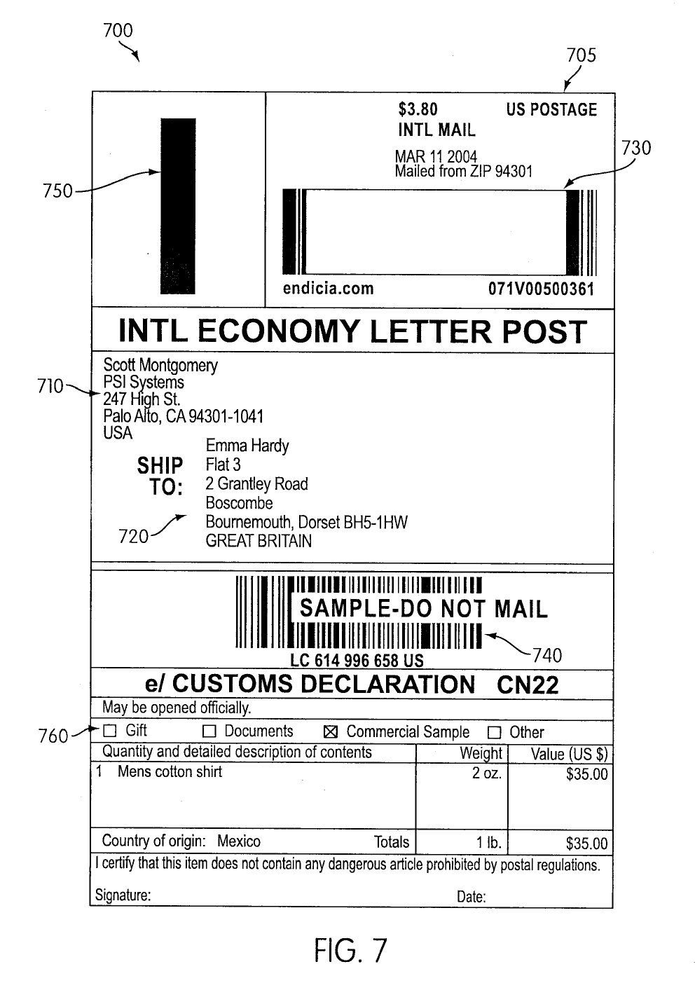

FIG. 7 illustrates an integrated shipping label 700 having both customs information and postage indicia 705, according to one embodiment. An example of an integrated shipping label is provided in U.S. patent application Ser. No. 11/165,647 by Harry T. Whitehouse entitled “INTEGRATED SHIPPING LABEL AND CUSTOMS FORM,” filed on Jun. 23, 2005, the contents of which is hereby incorporated by reference in its entirety. The sender's address 710 and the recipient's address 720 may appear in the center of the label 700, wherein the sender's address 710 may generally be left justified with “USA” automatically populated in bold capital letters. The recipient's address 720 and/or destination country may also be bolded with a large font. In one embodiment, the shipping label 700 may include a two-dimensional barcode 730 representing digitally-signed data, which may include the sender's USPS meter account number, origin ZIP code, postage date, and postage amount, among other things. In one embodiment, the customs form number (or one or more significant digits from the customs form number) may also be embedded in the postage indicia 705, thereby providing a unique identifier linked to the postage transaction. In one embodiment, a one-dimensional barcode 740 may also represent the customs form number. The one-dimensional barcode 740 may be used for tracking a package associated with the shipping label 700. Thus, because the barcode 730 and/or the barcode 740 may include the sender's USPS meter account number, the international shipment may therefore be traced back to the relevant sender.

In one embodiment, the systems and methods described herein may integrate heretofore disparate subcomponents used to ship packages from the US to foreign countries within a single, integrated label combining digital postage, addressing, and customs form information. Furthermore, the systems and methods may be used to transfer package data to a centralized and secure data storage cluster, whereby all data associated with a given package (e.g., sender, recipient, sub-class of mail, package contents, valuation, etc.) can be aggregated in an easily accessed data repository. This data can then be used to expedite the flow of goods through foreign customs operations, assist in the tracking of packages, enhance the security and safety of the common carriers transporting the packages, and assist law enforcement agencies in both the US and abroad to investigate potential criminal or terrorist activity.

The ability to produce such a shipping label also represents a tremendous time savings for international shippers because the addressing, postage payment, and customs form preparation may be integrated. These systems and methods can also be extended to manage postage discount programs, which are common in the United States for certain sub-classes of international mail. Discount programs managed via the embodiments described herein can be administered at lower costs and reduce USPS financial losses by eliminating induction accounting errors and omissions that are common with permit-based mailing programs.

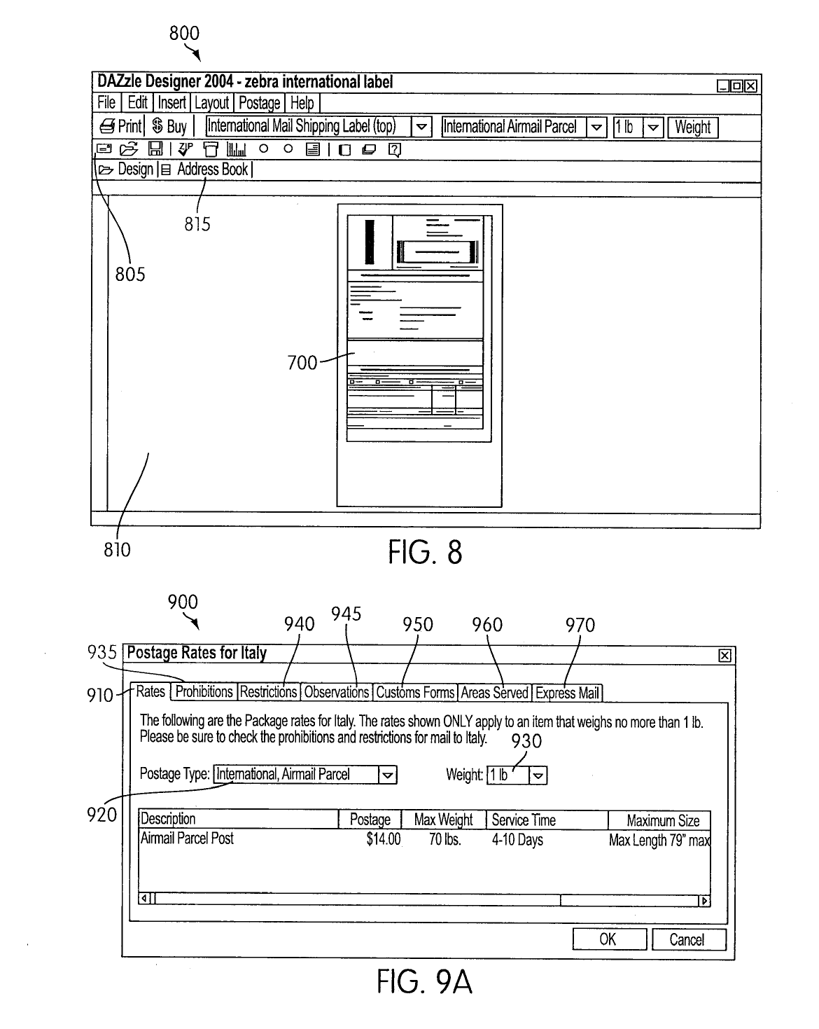

The systems and methods described herein may further leverage the features of a centralized online postage system, such as that described in U.S. Pat. No. 6,005,945 incorporated by reference above, which allows for the real-time capture of data associated with a postage transaction. Mailing software utilized by the online postage system can be implemented to allow a user to generate an integrated label 700 having the addressee information, the appropriate postage, and customs information. An exemplary graphical user interface 800 for such mailing software is shown in FIG. 8. For example, in one embodiment, the user interface 800 may include a workspace 810 that allows a user to design an integrated label 700. The user interface 800 may further include a toolbar 805 that provides tools such as “save,” enabling a user to save a design on a non-volatile memory, and “file open,” enabling the user to open the saved design. Also included may be an “address book” 815 tool, enabling the user to store a plurality of addresses that can be readily merged with the designed shipping label 700.

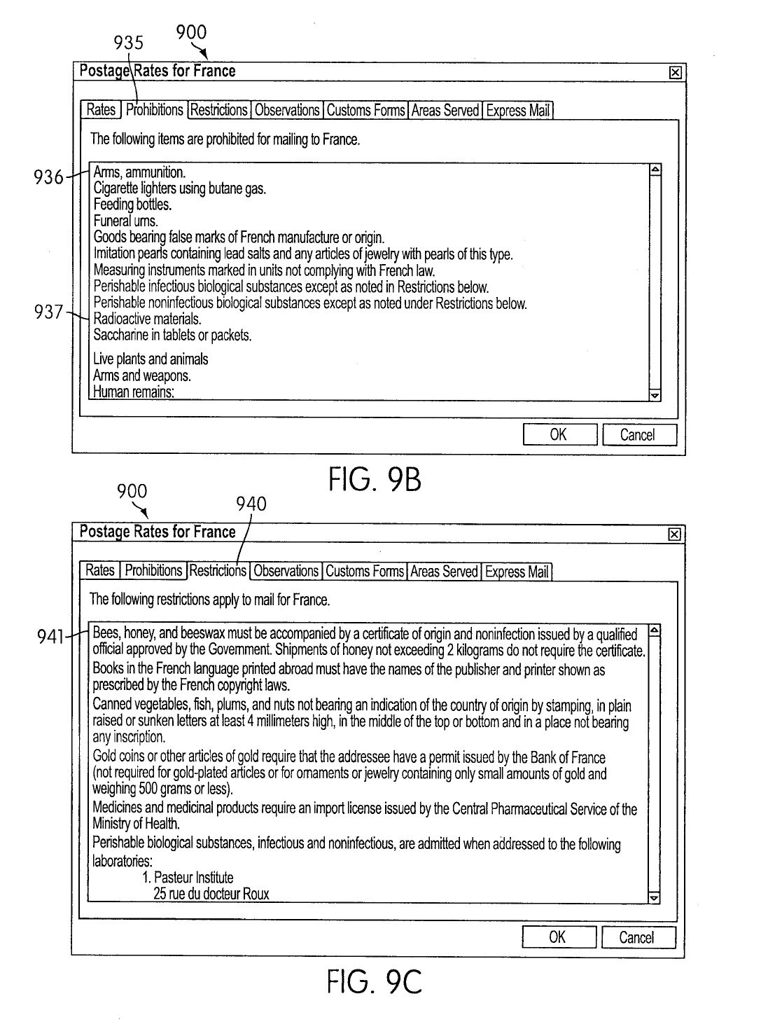

In one embodiment, the mailing software may further include a helper screen 900, as shown in FIG. 9, which may be configured to assist the user in determining the correct amount of international postage, import restrictions to the foreign country, and customs form requirements for the shipping label 700, among other things. As shown in FIG. 9a, the helper screen 900 may provide a user with a plurality of tools to establish postage rates for an international location, such as Italy 910. The screen 900 may allow a user to establish postage type 920 (e.g., airmail, high priority, etc.) and weight 930. The postage rate may then be calculated based on the user's established information. Also included may be tools for restrictions 940, prohibitions 935, observations 945, customs forms 950, areas served 930, and express mail service 970.

Turning to FIG. 9b, the prohibitions tool 935 of the user interface 900 is shown. The tool 935 may show a list of goods 936 prohibited for mailing to a particular country (e.g., France). Turning to FIG. 9c, the restrictions tool 940 of the user interface is shown. The tool 940 may show a list of restrictions 941 that apply to mail to a particular country (e.g., France). This information may generally be provided by the destination country and disseminated by the USPS to international shippers. Although this information has historically been available in printed catalogs, the information has recently been made available electronically as well. As such, in one embodiment, the user interface 900 may utilize the electronic prohibitions and restrictions information.

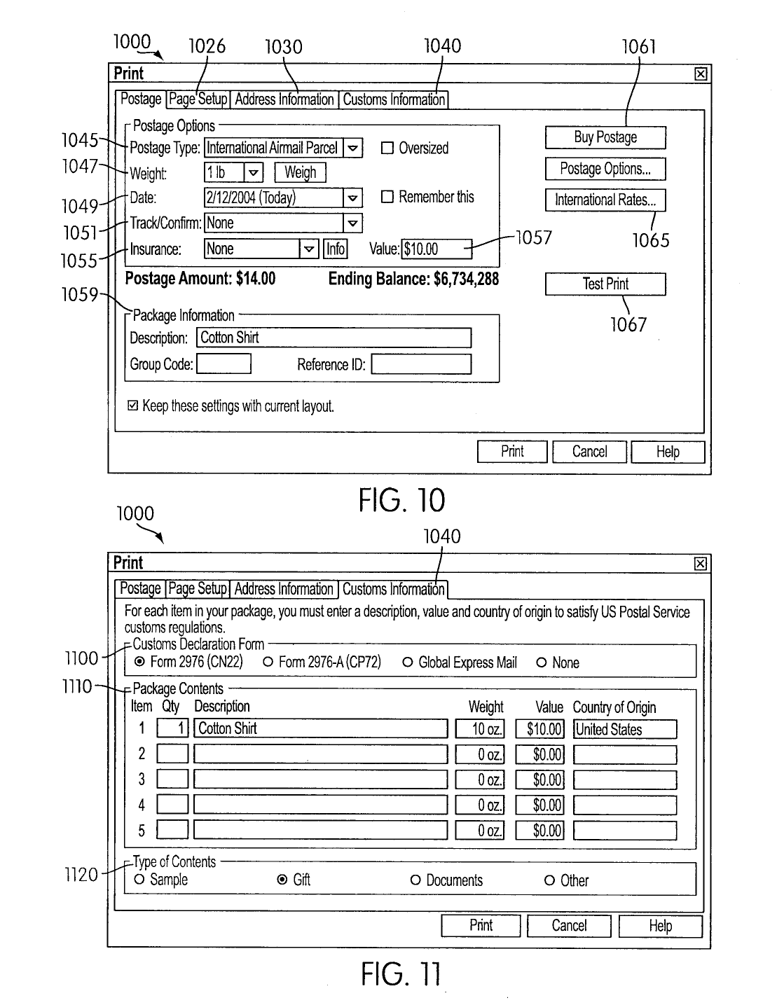

Turning to FIG. 10, the mailing software may include another user interface 1000 for establishing and printing an integrated shipping label 700. The user interface 1000 may allow a user to establish postage type 1045, weight 1047, date 1049, track option 1051, insurance 1055, and value 1057. The user interface 1000 may also allow a user to purchase the postage 1061, international rates 1065, and print a test label 1067. The user interface 1000 may further allow a user to provide package information 1059, such as a package description. Other tools within this user interface may include page setup 1026, address information 1030, and customs information 1040.

Turning to FIG. 11, the customs information 1040 tool of the print user interface 1000 is shown. The customs information tool 1040 may allow a user to select the proper form 1100, provide a description of the contents 1110, and select the type of contents 1120 (e.g., sample, gift, document, other, etc.).

By using the postage indicia 705 described above in the universal shipping labels 700, which may be generated by the online postage system described above, each label printed can have an associated data record stored at a central location. In the case of domestic packages, the data may include the complete destination address, complete sender information, tracking or delivery confirmation number, package weight, postage applied, and mail class (e.g., Priority). In the case of an international package, the data may be expanded to include a description of contents, the value of the contents, and the country of origin for the goods. Further, all of this data may be indexed by a unique identifier (i.e., the customs form number).

This approach may alleviate the need for the thirty day storage of a customs form hardcopy at the origin Post Office. In the existing system, if the information is needed, the origin Post Office must be located, contacted, and a manual search for the information must be instituted. These systems and methods provide a simple index lookup procedure, which can be accessed over the Internet (e.g., via a Web browser). By simply entering a unique identifier (e.g., the customs form number), data about the sender, the package shipped by the sender, and/or status of the package may be retrieved. This type of information can then be used by customs personnel (in the US and foreign countries), air transportation coordinators, and law enforcement to further advance the safety of commercial shipping.

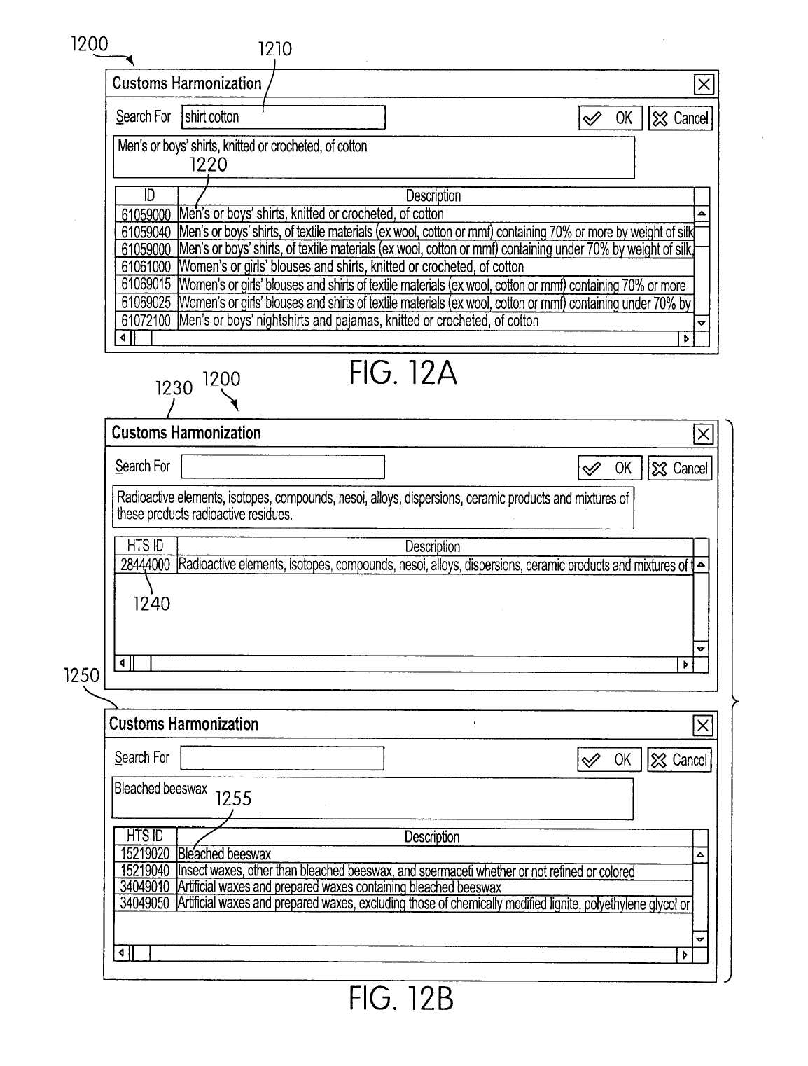

To achieve some measure of standardization in customs-related information globally, the Universal Postal Union (“UPU”) has developed a numerical “harmonization” table, which maps products into numerical Harmonized Tariff Schedule (HTS) codes. The US and other countries have been moving towards requiring shippers to provide both product description and HTS codes as part of the customs form information. However, the HTS code requirement may create a burden on those unfamiliar with the codes. As such, in one embodiment, the mailing software may further include a lookup mechanism that allows the appropriate HTS code to be determined (e.g., user interface 1200 shown in FIG. 12a). In one embodiment, the user interface 1200 may provide a text box 1210 that allows a user to perform a text-based search for the proper HTS code, which may be provided in a list box 1220. For example, typing the words “cotton” and “shirt” in the text box 1210 may result in a Boolean search through the HTS database to find all occurrences of the words “cotton” and “shirt.” Note that customs organizations make a distinction between cotton shirts and shirts made of other materials, for example. Similarly, there may be a distinction between men shirts, women's shirts, and night shirts, while wheeled toys may be considered distinct from general toys, among other distinctions.

This simplified lookup process can be integrated into the mailing software when a user is filling out the contents descriptions for the customs form. In this way, the user can select among standardized descriptive text defined within the harmonization table, rather than having to typing in free-form (and potentially incorrect or vague) information. Alternatively, the lookup process may be used as an adjunct or an option to a free-form goods description. Recording contents data by HTS code rather than free-form text may also have benefits in reducing the data storage requirements for historical shipment information stored at the centralized postage server site.

Turning back to FIGS. 9b and 9c, the list of prohibited goods 936 and restricted goods 941 may pose difficulty for a user attempting to compare the list to the description of the actual item being shipped by the user. An approach to alleviate this task may include recasting the lists 936 and 941 into a corresponding HTS code or a corresponding Harmonized Tariff Schedule (HTS) number. For example, radioactive materials 937 in the list of prohibited goods 936 may correspond to HTS number 28444000. Turning to FIG. 12b, the user interface 1200 is shown with a search performed for “radioactive” materials 1230. The search results 1240 may reveal that only one HTS number corresponds with such type of goods. Also shown is a search performed for “bees” 1250. In this case, the search results 1255 may reveal multiple entries. Any of these entries may trigger a warning message to the user, instructing the user that there restrictions/prohibitions are in place for such type of goods being sent to the desired country.

If the prohibitions and restrictions are cast in terms of HTS numbers for each country, the mailing software can enforce the prohibitions and issue warnings for restricted items. This can be achieved by requiring that descriptions be selected from a searchable HTS list and not typed free-form, and the selected HTS numbers could then be compared to the list of restricted and prohibited HTS numbers for the country of interest. The software can provide a hard lock-out to prevent the user from printing the shipping label and accompanying customs form or issue warning messages of varying severity. Alternatively or in addition, for example, the mailing software can open a window in the graphical user interface stating “WARNING! ITEM NOT AUTHORIZED FOR SHIPPING TO SELECTED COUNTRY.”

In addition to prohibiting or restricting particular goods from being shipped to a specific destination country, the mailing software may further present the shipper via a graphical user interface a list of individuals or organizations in a given country who have been designated as “no-ship” entities by an authority of an originating country (e.g., the US Department of Commerce or the US Homeland Security Department). When the shipper attempts to ship to a “no-ship” individual or “no-ship” organization, the mailing software can alert the shipper and/or prevent the shipper from generating a shipping label for the goods.

In one embodiment, the mailing software may further alert the shipper and/or merchant as to goods which are classified as “dual-use” and thus may have export restrictions. “dual-use” items are items that can be used for commercial and military purposes. For example, a personal computer can be classified as a “dual-use” item. In which case, the shipper may have to certify by acknowledging that the goods being shipped (e.g., the personal computer) are not intended for military purposes, for example, by checking a designated area in the graphical interface of the mailing software.

There are a number of advantages in an international shipping system that fundamentally operates using the HTS numbers. First, language barriers are eliminated at foreign customs operations. For example, a Bulgarian customs official may not be very well versed in English, but the official will know the international HTS numbers relevant to Bulgaria intimately.

Second, the use of HTS numbers offers the shipper an automated software-based mechanism to insure that restricted or prohibited goods are not inadvertently being shipped to foreign countries. For such goods, there is no guarantee that the goods will be returned to the shipper. Thirdly, the use of HTS numbers may provide a convenient and uniform way to construct electronic manifests of what goes on any aircraft of ship. This may be significant depending on the current geo-political situation.

As described above, the online postage system can transmit the detailed list of items (including HTS number) about a shipment to both the central postage services and those of the USPS using the customs form number as an index for this detailed data. Thus, scanning a customs form barcode created by the systems described above may allow for an instantaneous lookup of all the items in that package, including the HTS number for each item.

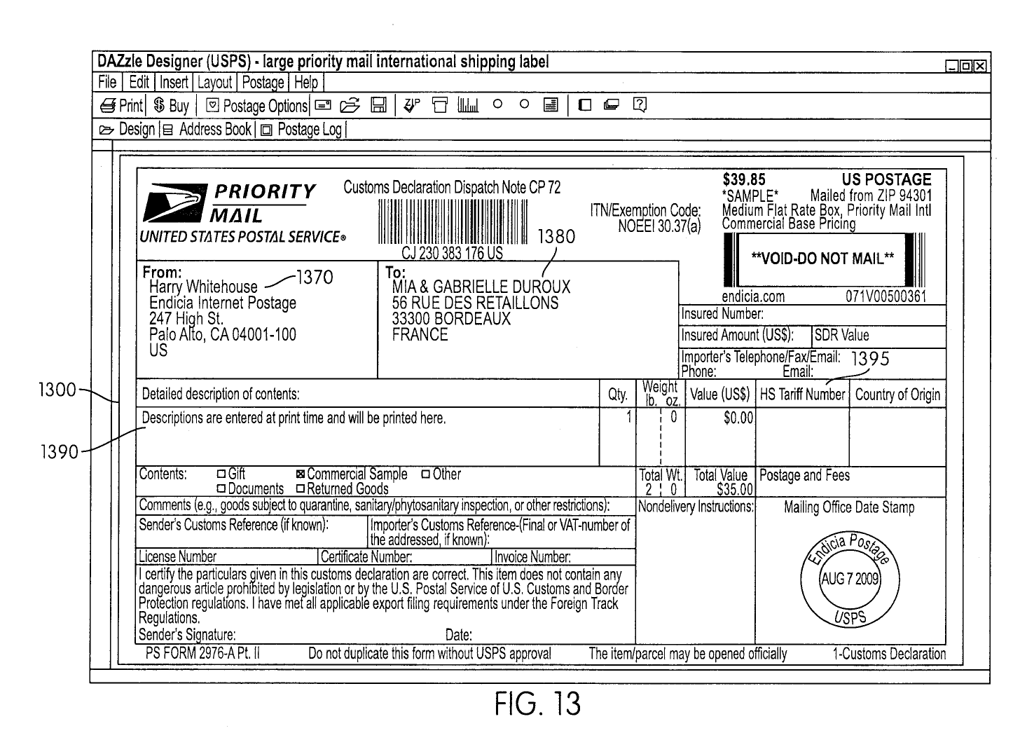

In one embodiment, mailing software utilized by the online postage system can be implemented to allow a user to generate a shipping label and customs declaration form 1300, such as a CP 72 form, as shown in FIG. 13. The customs declaration form may include information such as sender information 1370, recipient information 1380, details of contents 1390, and HTS code 1395.

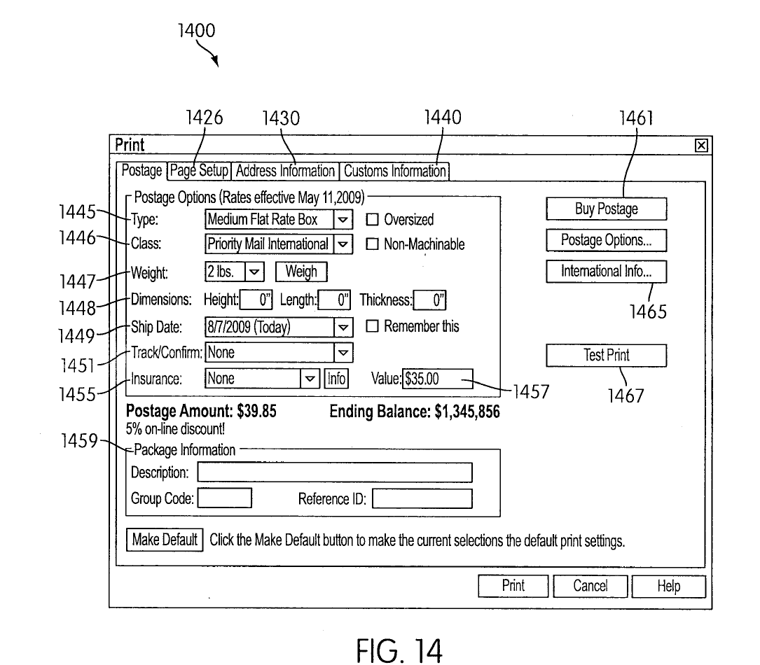

Turning to FIG. 14, the mailing software may include a user interface 1400 for establishing and printing shipping label and customs declaration form 1300. The user interface 1400 may allow a user to establish postage type 1445, postage class 1446, weight 1447, ship date 1449, track option 1451, insurance 1455, and value 1457. The user interface 1400 may also allow a user to purchase the postage 1461, international rates 1465, and print a test label 1467. The user interface 1400 may further allow a user to provide package information 1459, such as a package description. Other tools within this user interface may include page setup 1426, address information 1430, and customs information 1440.

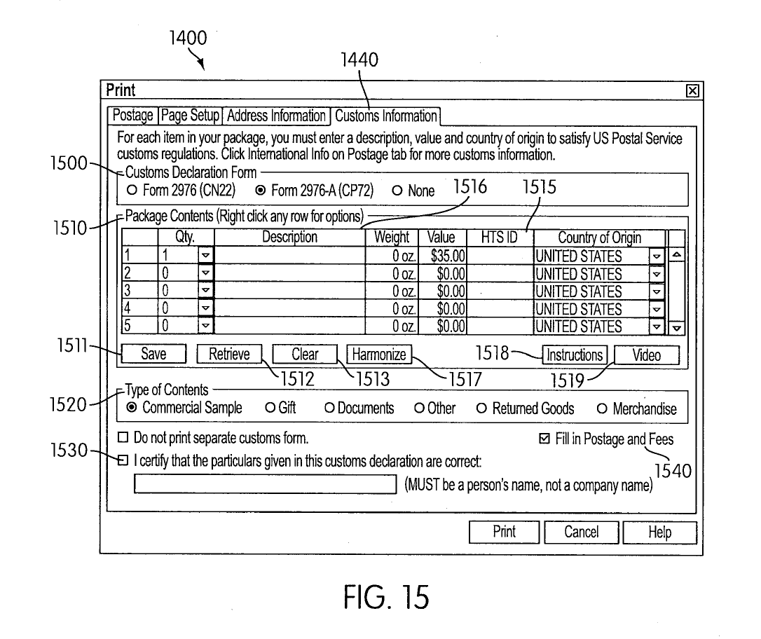

Turning to FIG. 15, the customs information tool 1440 of the user interface 1400 is shown. The customs information tool 1440 may allow a user to select the proper form 1500, provide a description of the contents 1510, select the type of contents 1520 (e.g., sample, gift, document, other, etc.), certify the customs declaration is correct 1530, and fill in postage and fees. In providing a description of the contents 1510, a user may provide HTS IDs, or HTS codes, in a “HTS ID” field 1515 and an associated description in a “Description” field 1516. The customs information tool 1440 may allow a user to save 1511, retrieve 1512, and clear 1513 data relating to the description of the contents 1510. In addition, a user may view instructions 1518 and video 1519. The customs information tool may allow a user to harmonize 1517.

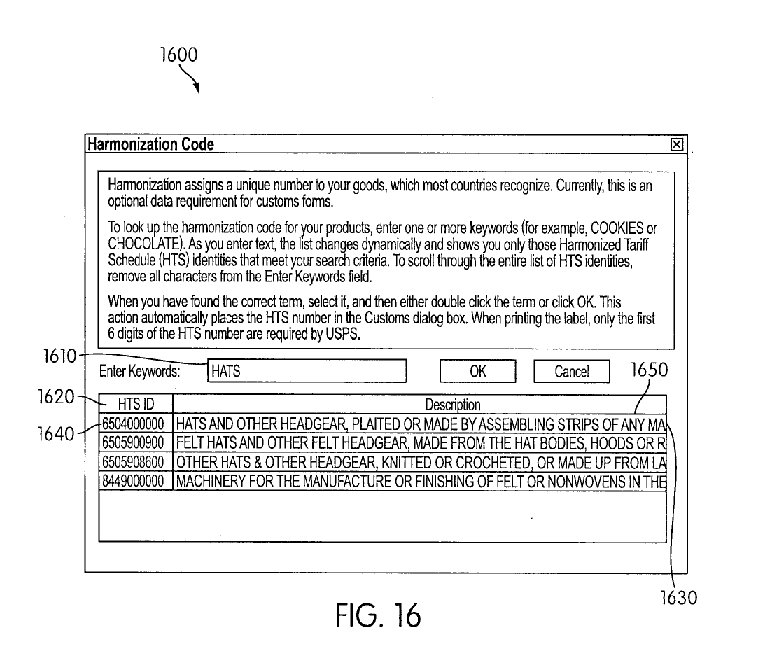

Turning to FIG. 16, to harmonize 1517 (shown in FIG. 15), user interface 1600 may provide a text box 1610 that allows a user to perform a text-based search for the proper HTS code, which may be provided in a list box 1620. For example, typing the word “HATS” in the text box 1610 may result in a search through the HTS database to find all occurrences of the word “HATS.” The user interface 1600 allows a user to select a particular line 1630 corresponding to a particular user-desired HTS code 1640. The particular user-desired HTS code 1640 may have an associated description 1650.

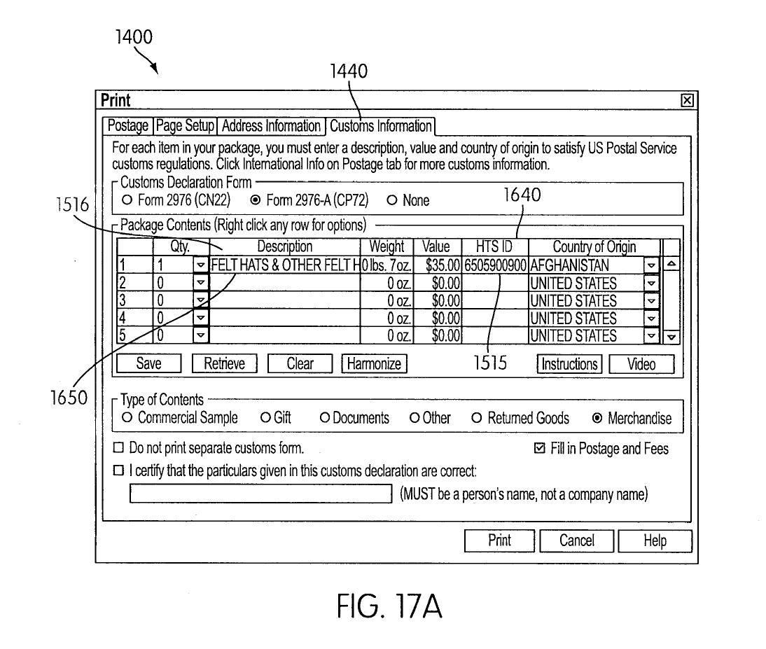

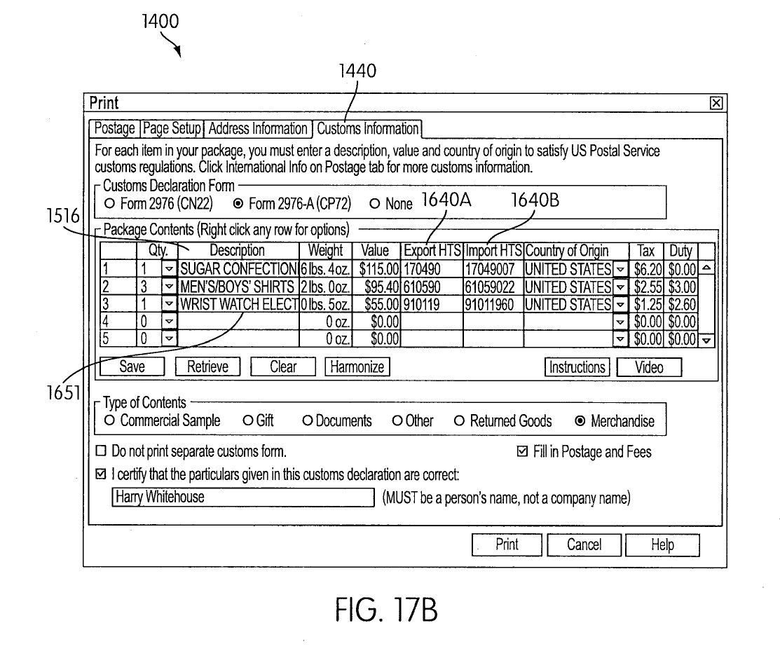

Turning to FIG. 17a, in one embodiment, if a user selects a particular HTS code in user interface 1600, the selected HTS ID 1640 may be provided automatically to the HTS ID field 1515. The associated description 1650 also may be provided automatically to the Description field 1516.

In another embodiment, as shown in FIG. 17b, two types of HTS codes can be retrieved from the HTS database. A first type of HTS code is an Export HTS code 1640A and a second type of HTS code is an Import HTS code 1640B. An Export HTS code is an HTS code that is established for the exporting country and an Import HTS code is an HTS code established for the importing country. For example, if goods 1516 are shipped from United States to France, the goods 1516 are assigned an HTS Export code 1640A in the US and an HTS Import code 1640B in France. For example, as shown in FIG. 17b, in the goods description field 1651 “sugar confection” is assigned Export HTS code “170490” and Import HTS code “17049007.” In one embodiment, as shown in FIG. 7b, the Export HTS code and Import HTS code are the same up to the first six digits. However, the HTS Import code contains additional digits and these additional digits change according to the destination country receiving the shipment. The Export HTS code 1640A is presented or sent to the originating country export authority when processing the shipment of the goods. The Export HTS code 1640A is used by the originating or exporting country (e.g., US) to allow customs of the originating country and department of commerce (in the case of US) to record what is going out of the country (e.g., what is going out of the US). The Import HTS code 1640B assigned to the importing or destination country (e.g., France) is used to compute taxes and duties. For example, in the above case where “sugar confection” is shipped from US to France the shipping software computes the Tax and Duty (respectively, $6.20 and $0.00) automatically using the Import HTS code.

In one embodiment the process of selecting the proper customs form, the description for the goods to be shipped and the determining of the HTS values (including Import and Export HTS values) and the calculating of corresponding duties and taxes is performed using a flow of sequence of graphical user interfaces or windows (dialog window sequence) for guiding the shipper to enter appropriate input data or parameter or select from a menu an appropriate entry.

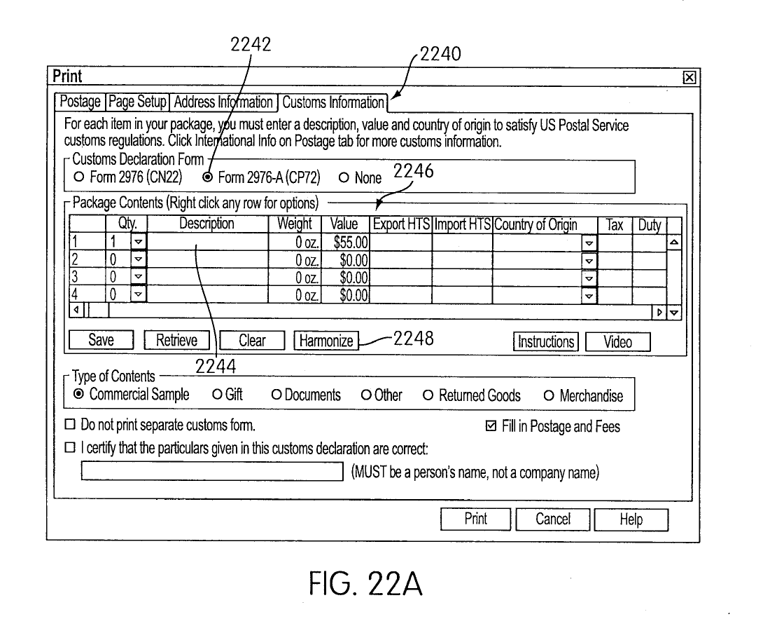

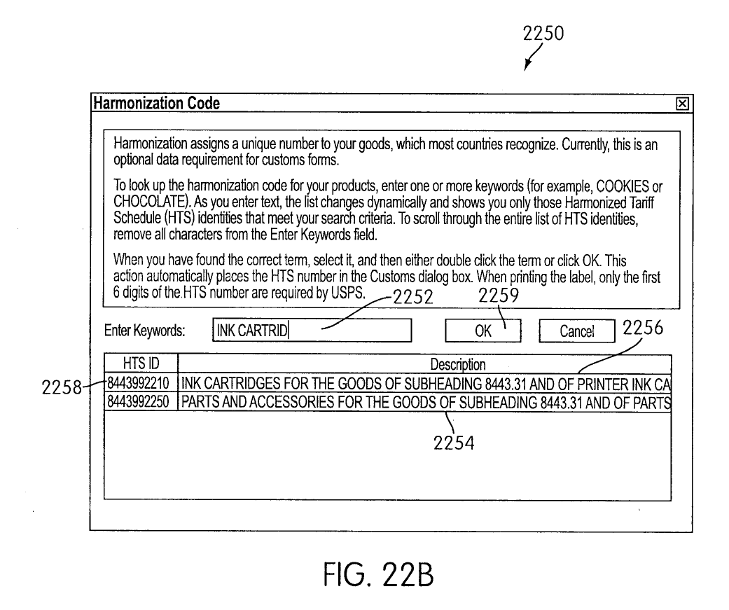

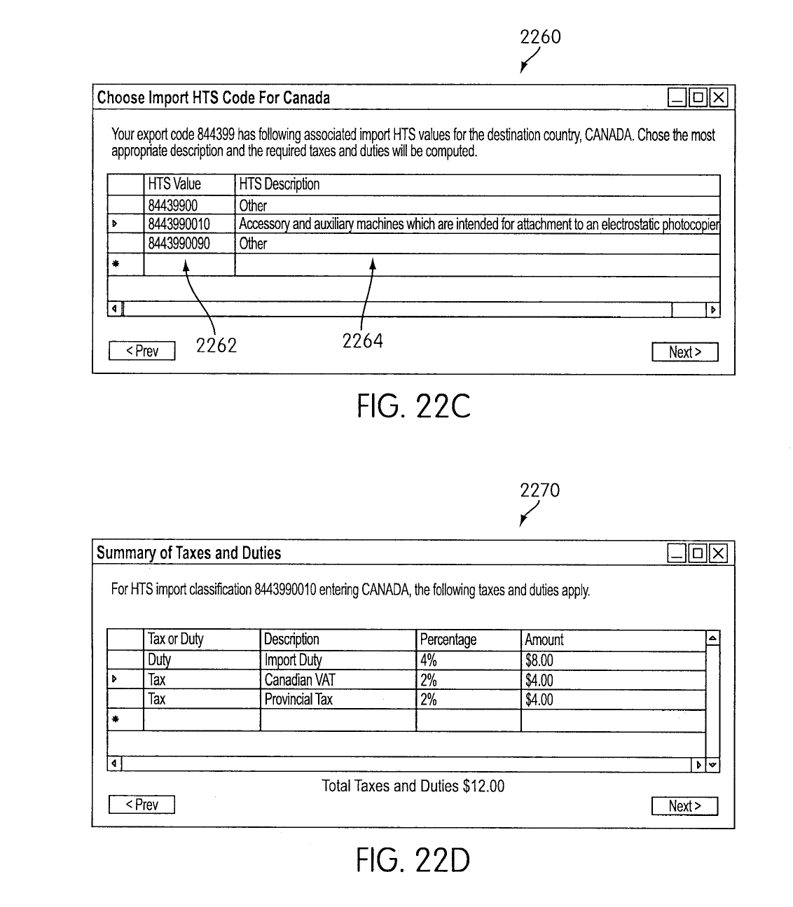

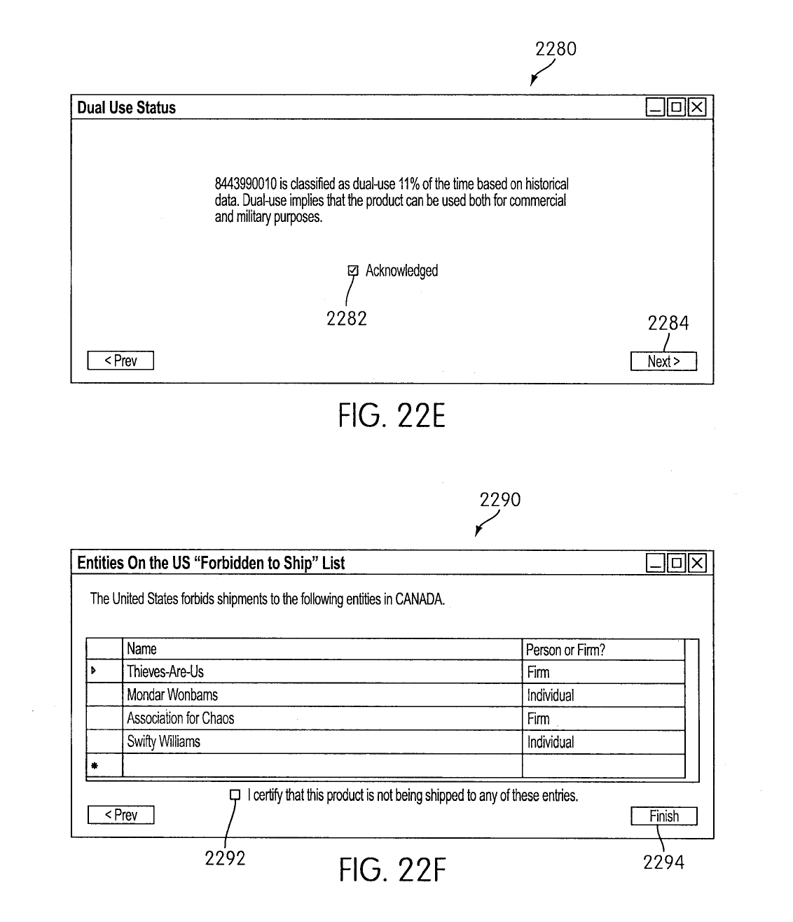

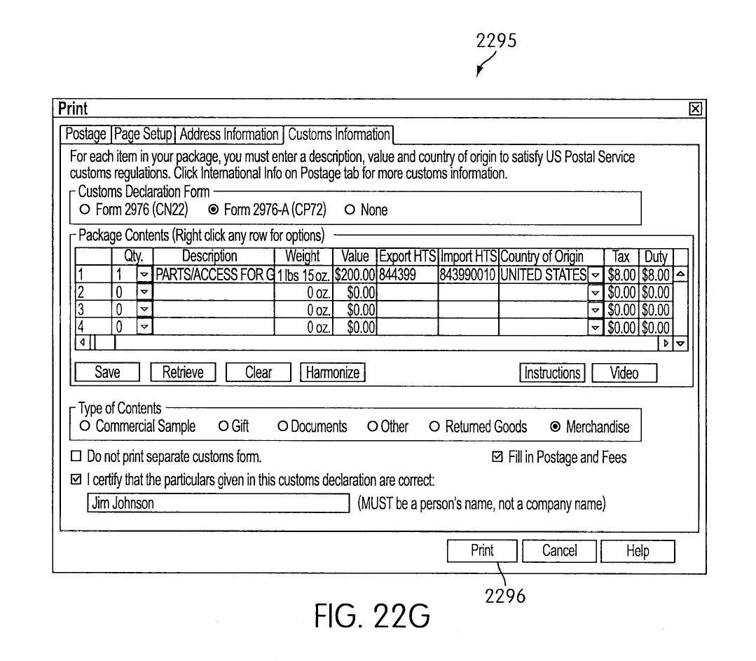

FIG. 22A shows the customs information window 2240, according one embodiment of the present invention. The customs information window 2240 may allow a user to select the proper customs form by clicking on button 2242. The user can then select a first row 2244 within “package content” window 2246 and for example input quantity “1”. The user does not need to input any description of the goods to be shipped in the first row yet. By pressing on “Harmonize” button 2244 while on the first row, the user is presented with a new window or graphical user 2250 interface labeled “Harmonization Code” or “Export Harmonization Code” or any other label as may be appropriate.

FIG. 22B shows an example of the “Harmonization Code” window 2250, according to an embodiment of the present invention. The “Harmonization Code” window 2250 can be retrieved by the shipping software from a local memory of the user's personal computer or can also be retrieved by the shipping software from the world wide web. Window 2250 allows the user to look up a harmonization code for a corresponding product or goods to be shipped. For example, the user may enter the words “ink cartridge” within space 2252. The shipping software dynamically searches for product description containing the words “ink cartridge” as the user types the keywords. The user is presented with a list of products or product descriptions 2254 that contain the typed keyword “ink cartridge.” The user can then select one description from the list 2254 that matches as closely as possible with the products or goods the user is shipping. For example, the user can select “Ink Cartridges for the Goods of Subheading 8443.31 and of Printer” at 2256. Next to each description of the product is also listed the Export HTS code 2258 associated with the product. For example, the Export HTS code “844399” is associated with “Ink Cartridges for the Goods of Subheading 8443.31 and of Printer” selected by the user as being the product being shipped. As stated in the above paragraphs, the Export HTS code is an HTS code that is established for the exporting country (for example, in this case the US). Once the user has selected the appropriate product description 2256 and associated Export HTS code 2258 for the goods the user is shipping, the user can then click on button “OK” 2259 or double click on the desired product description 2256. When printing the shipping label, only the Export HTS code is required by the United States Postal Service as the Export HTS code is used by the originating or exporting country (e.g., in this case the US) to keep track of the goods that are being exported.

However, a more detailed HTS code or an Import HTS code is used by the importing country to determine the appropriate duties and taxes. For example, if the user intends to ship the goods to Canada, a look up table or database of HTS codes that is used by the destination or importing country (in this example Canada) can be used to determine the appropriate Import HTS code.

FIG. 22C shows a graphical user interface or window 2260 for allowing a user to select an appropriate Import HTS code associated with the Export HTS code 2258 (e.g., “844399”) from a list of Import HTS codes 2262. The user is presented with a list of possible product descriptions 2264 from which the user can select the product description that corresponds as closely as possible to the goods the user is shipping to Canada. For example, the user can select “Accessory and auxiliary machines which are intended for attachment to an electrostatic photocopier . . . ” and the associated Import HTS code “8443990010.” The shipping software can then compute the appropriate taxes and duties based on the selected Import HTS code for the destination country Canada. In one embodiment, this is performed by accessing the database for taxes and duties of the destination country (e.g., in this example Canada). The database can be locally stored at the user's personal computer or stored remotely and accessed via a world wide web service. The Import HTS code and the computed duties and taxes for that Import HTS code are summarized in a table shown in window 2270. For example, for the Import HTS code “8443990010” selected by the user the taxes and duties are computed and provided in table 2270. The Import duty is computed using the ongoing 4% rate in Canada and the Canadian VAT tax and Canadian Provincial tax are computed using the ongoing rates of 2%. It is noted that depending on the destination country there may be more than one type of tax that can be levied. Based on a purchase value or assigned value of the product to be shipped (e.g., $200) and the percentage rates for the import duties and taxes, the amount of the duties and taxes are computed (e.g., respectively $8.00, $4.00 and $4.00) and the total taxes and duties is calculated by adding all the taxes and duties (e.g., $12.00).

After calculating the total duties and taxes, the user can click on the button “Next” at 2272 to further advance the shipping software to a next step. Upon clicking on the button “Next” at 2272, a window or graphical user interface 2280 pertaining to “dual use status” is displayed.

FIG. 22E shows an example of the “Dual Use Status” window 2280, according to one embodiment of the present invention. The “dual use status” window 2280 alerts the user as to goods which are classified as “dual-use” and thus may have export restrictions. “Dual Use Status” items are items that can be used for commercial and military purposes. For example, in the present case, the product with an Import HTS code of “8443990010” is classified as dual-use 11% of the time based on historical data. In which case, the user is prompted to acknowledge that the ink cartridge is classified as a “dual-use” item by checking box 2282. After acknowledging the “Dual Use Status” of the item, the use can click on button “Next” 2284 to advance the shipping software to a next step.

After clicking on button “Next” 2284, the shipping software can open another window 2290 to alert the user about entities in the destination country (e.g., Canada) which the US (e.g., Homeland Security Department, Department of Commerce, etc.) are classified in the “Forbidden to Ship” or “no-ship” list. In order to move forward, the user must certify that the product or goods being shipped is/are not being shipped to any of the listed entities in the destination country. This certification can be performed, for example, by clicking or checking box 2292. Once this certification is done, the user can then click on button “Finish” 2294 so that the software displays a summary window 2295. If the user attempts to click on button “Finish” 2294 without first certifying that the product will not be shipped to any of the listed “no-ship” entities, the shipping software will not be able to advance and the summary window 2295 will not be displayed.

FIG. 22G is window or graphical user interface summarizing the various input parameters described in the above paragraphs such as the description of the goods or product being shipped, the quantity of the product, the weight of the product, the value of the product, the Import and Export HTS codes, the country of origin (e.g., US), the amounts of taxes and duties computed by the shipping software and the type of customs form used (e.g., Form 2976-A), and any other pertinent data, according to an embodiment of the present invention. The user can verify the data before generating and printing the customs forms by clicking on the button “Print” 2296.

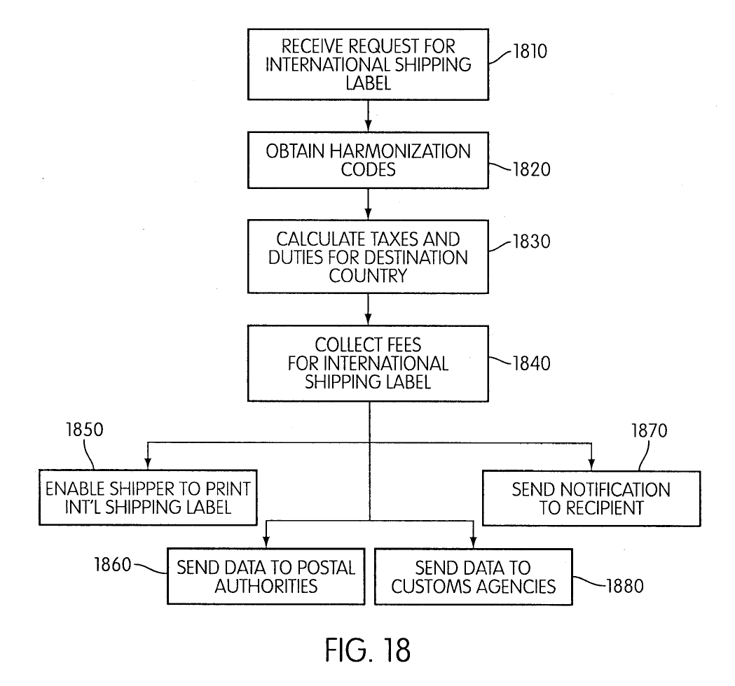

Turning to FIG. 18, an exemplary process is illustrated for managing landed cost and harmonization for international packages. In particular, the process illustrated in FIG. 18 may be performed at the online postage system described in further detail above, wherein the online postage system may receive a request for an international shipping label in block 1810. For example, in one embodiment, a shipper may provide the request for the international shipping label to the online postage system using the mailing software described above, wherein the request may include at least information relating to the shipper (e.g., an origin address and ZIP code, a USPS meter account number, etc.) in addition to a recipient of a package that will bear the international shipping label (e.g., a destination address and country).

Furthermore, in one embodiment, the request received at the online postage system in block 1810 may further include a description of contents for the package that will bear the international shipping label and an estimated value for the contents. The online postage system may maintain a database containing various HTS codes (including Export HTS codes and Import HTS codes) that correspond to various different product types and a master list of tariff numbers corresponding to the Import HTS codes for various different countries. The database may be maintained as a SQL server for example. For example, the online postage system may populate the database with the Export and Import HTS codes based on the numerical harmonization table developed by the UPU, as described above, and may further populate the database with the master list of tariff numbers using data maintained by the International Customs Tariffs Bureau. Thus, in one embodiment, the online postage system may search the database in block 1820 to obtain one or more international HTS codes (Export HTS codes and Import HTS codes) corresponding to one or more products that match the description of the contents (e.g., using an XML request or other database transaction). For example, the shipper may provide one or more search terms and/or free-form text describing the contents of the international package, wherein block 1820 may include the online postage system querying the database (e.g., using a Boolean search) to obtain the corresponding HTS codes (Export HTS codes and Import HTS codes).

In one embodiment, the online postage system may then further query the HTS database (i.e., retrieve the Import HTS code from the database) in block 1830 to calculate an estimate for taxes and duties, including any taxes and duties that can be pre-paid, for the international package to be shipped to the destination country (e.g., France) identified in the label request. In one embodiment, because the international taxes and duties for the package may differ depending on the particular contents of the package and the particular destination country, the database may have a primary index based on country (e.g., country name, country code, etc.) and a secondary index based on the Import HTS codes in the harmonization table. As such, to calculate the estimated taxes and duties in block 1830, the online postage system may map the Import HTS codes obtained for the contents in block 1820 to the relevant tariff schedule, wherein the tariff schedule may represent the tariffs, taxes, and other duties for shipping international packages in terms of valuation for such contents. For example, the tariffs, taxes, and other duties may generally be represented as a number of currency units per currency units of valuation, which may further differ for the various HTS codes (e.g., a number of dollars per $100 valuation for contents corresponding to a certain HTS code). Thus, the estimated taxes and duties calculated in block 1830 may be a function of the destination country, the Import HTS codes corresponding to the contents, the value of the contents, the origin country of the shipper, and/or the origin country of the goods. It should be appreciated that the function of querying the database in block 1830 to calculate an estimate for taxes and duties may be implemented in a separate stand-alone system independent of the online postage system. For example, an XML request to a dedicated “tariff” server could send data relating to the destination country, the Import HTS codes corresponding to the contents for the destination country, the value of the contents, the origin country of the shipper, and/or the origin country of the goods. In response to the request, a user could receive a return message with estimated taxes and duties, including estimated taxes and duties that can be pre-paid.

In one embodiment, in response to calculating the estimated taxes and duties for the international package in block 1830, the online postage system may collect the appropriate fees for the international shipping label from the shipper in block 1840. In particular, the fees may generally include a cost for postage in the origin country and the destination country (including any insurance or other costs), and may further include the estimated taxes and duties calculated in block 1830. In one embodiment, the fees collected in block 1840 may further include a surcharge or service fee for enabling the shipper to pre-pay all of the postage, taxes, and duties required for the international package (e.g., a percentage surcharge on the estimated taxes and duties, a flat per-package service fee, etc.). As such, to collect the fees, block 1840 may include the online postage system billing the shipper in any appropriate manner. For example, in one embodiment, the online postage system may bill the shipper at periodic intervals for a sum total of all transactions entered into during a prior month or other period, deducting the fees from a postage balance for the shipper maintained at the online postage system, billing a credit card for the surcharge or service fee on a per-transaction basis, or in any other suitable manner, as will be apparent.

In another embodiment, instead of the online postage system collecting the appropriate fees for the international shipping label from the shipper in block 1840 (e.g., collecting among other costs the estimated taxes and duties), i.e., the user pre-pay for the taxes and duties, the online postage system simply indicates to the shipper the amount the shipper is expected to pay for the taxes and duties. If the taxes and duties are not collect at the time of generating the international shipping label, the destination country will collect the taxes and duties at final delivery of the shipment from the recipient.

Furthermore, various different countries may use brokers that work with local customs agencies to collect the appropriate taxes and duties for international packages, wherein the brokers typically require shippers to provide financial backup in addition to any pre-paid taxes and duties (e.g., to account for contingencies whereby the customs agencies rates the actual taxes and duties higher than the pre-paid estimate, the shipper inadvertently or intentionally misclassifies the contents of the package, etc.). As such, in one embodiment, collecting the fees in block 1840 may further include requiring the shipper to provide an acknowledgement in which the shipper agrees to further pay the online postage system any additional fees and/or duties that may subsequently be required to effect delivery of the international package. For example, in one embodiment, the mailing software may include a check box or other feature that requires the shipper to provide the acknowledgement in order to request an international shipping label indicating that taxes and duties have been pre-paid for the contents of the package that will bear the international shipping label. Furthermore, in one embodiment, the online postage system may install various auditing controls to track the HTS codes (Export HTS codes and Import HTS codes) and valuation data used to calculate the estimated taxes and duties for various shippers to detect potential and/or actual occurrences of fraud or abuse (e.g., when certain shippers consistently misclassify the contents and/or the valuation of the contents, the shippers may be disqualified from pre-paying taxes and duties temporarily or permanently, assigned a probationary status, etc.).

In one embodiment, in response to collecting the fees for the international shipping label from the shipper in block 1840, the online postage system may enable the shipper to print the international shipping label in block 1850. For example, as described in further detail above, the online postage system may generate a unique self-validating postage indicia or marking or symbol and a unique customs form number linked to a transaction associated with the international shipping label to indicate that landed cost for delivering the package containing the goods to the destination country have been pre-paid. In one embodiment, the marking or symbol can be of any type alphanumeric or drawing (e.g., an eagle, a maple leaf, etc.), picture, or a barcode, or a combination of these markings or symbols. The marking or symbol can be printed with visible or invisible ink. The shipper may print an integrated shipping label and customs form having the unique self-validating postage indicia or marking or symbol and the unique customs form number printed thereon. As such, in addition to the integrated shipping label having a customs declaration form that provides a description and an estimated value for the contents of the package having the integrated shipping label affixed thereto, the integrated shipping label and customs form may further indicate that postage, taxes, duties, and other costs have been pre-paid for the package. Furthermore, in one embodiment, a round stamp and/or a certification signature may be electronically printed on the integrated shipping label and customs form, as described in further detail below, whereby the integrated shipping label and customs form may be printed in a manner that complies with all of the requirements to deliver an international package to a foreign country. Thus, the shipper may then simply deliver the international package to any appropriate postal authority in any suitable manner to ship the international package. In the case of pre-paying for taxes and duties, the destination country shipping organization (e.g., postal service at the destination foreign country) when detecting that taxes and duties have been pre-paid (for example by detecting the presence of the symbol or mark) will simply deliver the package containing the goods to the intended recipient without collecting any taxes or duties from the recipient.

In one embodiment, in response to collecting the fees for the international shipping label from the shipper in block 1840, the online postage system further may send data relating to the transaction associated with the international shipping label to the appropriate postal authorities in block 1860, wherein the data may be sent to the appropriate postal authorities on a daily basis, weekly basis, or any other suitable basis. In one embodiment, the data sent to the appropriate postal authorities may relate to pre-paid and collected funds for taxes and duties associated with packages designated for delivery to certain foreign countries, and may further relate to specific transactions associated with the packages for which the taxes and duties have been pre-paid and collected. For example, in one embodiment, the online postage system may receive electronic manifests that describe the specific package transactions using techniques described in further detail in U.S. patent application Ser. No. 11/165,636, filed Jun. 23, 2005, entitled “Tracking Recordation System for Packages,” the disclosure of which is hereby incorporated by reference in its entirety.

As such, in one embodiment, the online postage system may use the electronic manifests to generate various records linking specific package transactions with corresponding pre-paid taxes and duties, whereby the records may be referenced to determine quantities of funds to be sent to certain foreign countries. Thus, block 1860 may include sending the relevant funds to the USPS, international postal services, foreign postal services, customs agencies, or any other suitable entity, as will be apparent (e.g., the online postage system may send the funds to the USPS, which then delivers the funds to the appropriate international or foreign authorities, or the online postage system may send the funds directly to the appropriate international or foreign authorities). In addition, block 1860 may further include sending the supporting package transaction data obtained from the electronic manifests to the USPS, international postal services, foreign postal services, customs agencies, or other suitable entities, whereby the appropriate customs or postal authorities may identify the specific packages that have pre-paid taxes and duties (e.g., in response to scanning a customs barcode printed on a shipping label affixed to a particular package that is linked to a particular transaction in which the taxes and duties were pre-paid).

Accordingly, when the packages that have pre-paid taxes and duties arrive at an International Service Center (ISC), the ISC may segregate such packages for expedited dispatch.

In one embodiment, sending the data to the appropriate postal authorities in block 1860 may enable the USPS and/or the appropriate ISC to similarly segregate packages bearing international shipping labels created using the techniques described herein (e.g., in response to scanning the customs barcodes printed on the international shipping labels and determining that such barcodes are linked to package transactions that have pre-paid taxes, duties, and other landed costs).

Additionally, in one embodiment, in response to collecting the fees for the international shipping label from the shipper in block 1840, the online postage system further may send a notification to the recipient of the international package associated with the international shipping label in block 1870. For example in one embodiment, the shipper may optionally provide an e-mail address or other information that can be used to notify the recipient of the international package in the request received in operation 1810. Accordingly, the online postage system may send an e-mail or other suitable notification to the recipient in block 1870 to indicate that the package has been shipped. For example, in one embodiment, the online postage system may determine whether an induction scan has occurred for the international package using techniques described in further detail in U.S. patent application Ser. No. 11/165,636, which is incorporated by reference above, wherein the notification may be sent to the recipient in block 1870 in response to the induction scan. Furthermore, in one embodiment, the notification sent to the recipient in block 1870 may further indicate that the shipper has pre-paid the taxes and duties for the international package, whereby the package can be delivered even if the recipient is not present to formally receive the package.

In one embodiment, the online postage system may send data relating to the transaction associated with the international shipping label to one or more authorities within the international postal system, such as customs agencies of one or more countries, in block 1880. The data may include Import HTS codes, content descriptions, and/or tracking numbers. The one or more authorities may receive the data days before the package arrives. In one embodiment, the data relating to multiple transactions may be indexed according to tracking numbers. By using tracking numbers as the index, the one or more authorities can pre-identify packages requiring and not requiring inspection, allowing personnel of the one or more authorities to more efficiently inspect packages and allows packages not requiring inspection to exit the customs process more quickly.

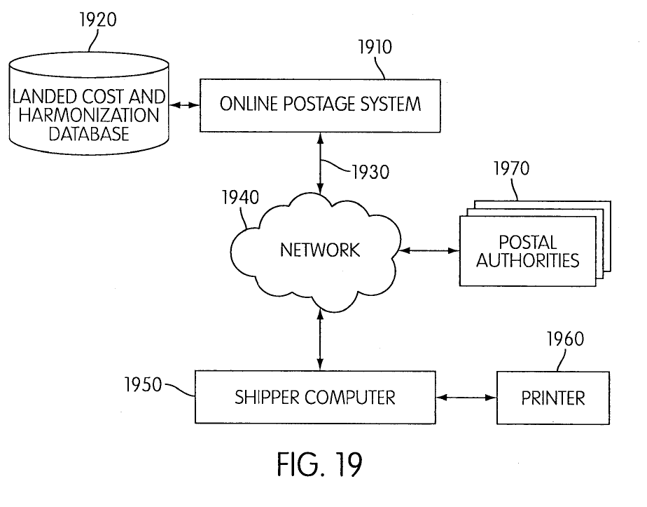

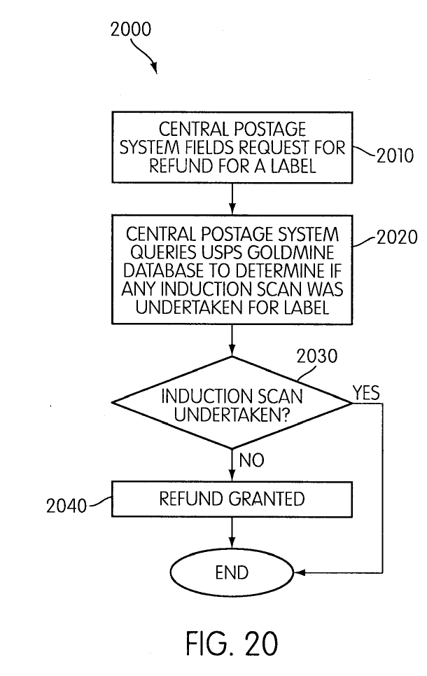

Turning to FIG. 19, an exemplary system is illustrated for managing landed cost and harmonization for international packages. In particular, the system illustrated in FIG. 19 may generally be configured to perform the method illustrated in FIG. 18, wherein an online postage system 1910 may receive a request for an international shipping label from a shipper computer 1950. In one embodiment, a shipper at the shipper computer 1950 may provide the request for the international shipping label to the online postage system 1910 using the mailing software described above. For example, the shipper computer 1950 may communicate the request to the online postage system 1910 over a network 1940, with the request then being received at the online postage system 1910 over a communications link 1930 that connects the online postage system 1910 and the shipper computer 1950 over the network 1940.

In one embodiment, the request received at the online postage system 1910 may generally include at least information relating to the shipper (e.g., an origin address and ZIP code, a USPS meter account number, etc.) in addition to a recipient of a package that will bear the international shipping label (e.g., a destination address and country). Furthermore, in one embodiment, the request received at the online postage system 1910 may further include a description of contents for the package that will bear the international shipping label and an estimated value for the contents. The online postage system 1910 may maintain a database 1920 containing information that may be used to determine landed costs and harmonization codes for the package that will bear the international shipping label. In particular, as noted above, the database 1920 may include various HTS codes that correspond to various different product types and a master list of tariff numbers corresponding to the HTS codes for various different countries.

In one embodiment, the online postage system 1910 may populate the database 1920 with the HTS codes (Import HTS codes and Export HTS codes) based on the numerical harmonization table developed by one or more postal authorities 1970 such as the UPU, and may further populate the database 1920 with the master list of tariff numbers using data maintained by one or more postal authorities 1970 such as the International Customs Tariffs Bureau. Thus, in one embodiment, the online postage system 1910 may search the database 1920 to obtain one or more international HTS codes (Import HTS codes and Export HTS codes) corresponding to one or more products that match the description of the contents in the request received from the shipper computer 1950 (e.g., using an XML request or other database transaction). For example, the shipper at the shipper computer 1950 may provide one or more search terms and/or free-form text describing the contents of the international package to the online postage system 1910, which may then query the database 1920 (e.g., using a Boolean search) to obtain the HTS codes (Import HTS codes and Export HTS codes) corresponding to the search terms and/or the free-form text describing the contents of the international package.

In one embodiment, the online postage system 1910 may then further query the database 1920 to calculate estimated taxes and duties that the shipper can pre-pay for the international package to be shipped to the destination country identified in the label request. In one embodiment, because the international taxes and duties for the package may differ depending on the particular contents of the package and the particular destination country, the database 1920 may be primarily indexed based on country (e.g., country name, country code, etc.) and secondarily indexed based on the HTS codes (Import HTS codes) in the harmonization table. As such, to calculate the estimated taxes and duties, the online postage system 1910 may map the Import HTS codes obtained from the database 1920 to the relevant tariff schedule maintained in the database 1920. For example, the tariff schedule may generally represent the tariffs, taxes, and other duties for shipping international packages in terms of valuation for such contents (e.g., a number of currency units per currency units of valuation, which may further differ for the various different Import HTS codes). Thus, the estimated taxes and duties that the online postage system 1910 calculates may be determined as a function of the destination country, the Import HTS codes for the contents, the value of the contents, the origin country of the shipper, and/or the origin country of the goods. As noted in the above paragraphs, the Export HTS codes are used by the originating country to simply tabulate or record the goods that have been exported and are not used per se to compute the taxes and duties. The Import HTS codes on the other hand, which contain more digits and are specific to the destination country, are used to compute the taxes and duties for the goods that shipped.

In one embodiment, in response to calculating the estimated taxes and duties for the international package, the online postage system 1910 may collect the appropriate fees for the international shipping label from the shipper at the shipper computer 1920. In particular, the fees may generally include a cost for postage in the origin country and the destination country (including any insurance or other costs), and may further include the estimated taxes and duties calculated by the online postage system 1910. In one embodiment, the fees collected by the online postage system 1910 may further include a surcharge or service fee for enabling the shipper to pre-pay all of the postage, taxes, and duties required for the international package (e.g., a percentage surcharge on the estimated taxes and duties, a flat per-package service fee, etc.). As such, to collect the fees, the online postage system 1910 may bill the shipper in any appropriate manner. For example, in one embodiment, the online postage system 1910 may bill the shipper at periodic intervals for a sum total of all transactions entered into during a prior month or other period, deducting the fees from a postage balance for the shipper maintained at the online postage system 1910, billing a credit card for the surcharge or service fee on a per-transaction basis, or in any other suitable manner, as will be apparent.

Furthermore, postal authorities 1970 in various different countries may use brokers that work with local customs agencies to collect the appropriate taxes and duties for international packages, wherein the brokers typically require shippers to provide financial backup in addition to any pre-paid taxes and duties (e.g., to account for contingencies whereby the customs agencies rates the actual taxes and duties higher than the pre-paid estimate, the shipper inadvertently or intentionally misclassifies the contents of the package, etc.). As such, in one embodiment, the online postage system 1910 may further require the shipper to provide an acknowledgement in which the shipper agrees to further pay the online postage system 1910 any additional fees and/or duties that may subsequently be required to effect delivery of the international package. For example, in one embodiment, the mailing software at the shipper computer 1950 may be arranged to display a check box or other visual feature that the shipper must check or otherwise acknowledge in order to request an international shipping label with pre-paid taxes and duties. Furthermore, in one embodiment, the online postage system 1910 may include various auditing controls to track the HTS codes and valuation data used to calculate the estimated taxes and duties for various shippers to detect potential and/or actual occurrences of fraud or abuse (e.g., when certain shippers consistently misclassify the contents and/or the valuation of the contents, the shippers may be disqualified from pre-paying taxes and duties temporarily or permanently, assigned a probationary status, etc.).

In one embodiment, in response to collecting the fees for the international shipping label from the shipper, the online postage system 1910 may enable the shipper computer 1950 to print the international shipping label on a printer 1960 coupled to the shipper computer 1950. For example, as described in further detail above, the online postage system 1910 may generate a unique self-validating postage indicia and a unique customs form number linked to a transaction associated with the international shipping label or marking or symbol and a unique customs form number linked to a transaction associated with the international shipping label to indicate that landed cost for delivering the package containing the goods to the destination country have been pre-paid. In one embodiment, the marking or symbol can be of any type alphanumeric or drawing (e.g., an eagle, a maple leaf, etc.) or a barcode, or a combination of these markings or symbols. The marking or symbol can be printed with visible or invisible ink. The shipper computer 1950 may use the printer 1960 to print an integrated shipping label and customs form having the unique self-validating postage indicia and the unique customs form number printed thereon. As such, in addition to the integrated shipping label having a customs declaration form that provides a description and an estimated value for the contents of the package having the integrated shipping label affixed thereto, the printer 1960 may print the integrated shipping label and customs form in a manner that further indicates that postage, taxes, duties, and other costs have been pre-paid for the package. Furthermore, in one embodiment, a round stamp and/or a certification signature may be electronically printed on the integrated shipping label and customs form, whereby the integrated shipping label and customs form may be printed in a manner that complies with all of the requirements to deliver an international package to a foreign country. Thus, the shipper may then simply print the integrated international shipping label using the printer 1960, affix the international shipping label to the international package, and then suitably deliver the international package to any appropriate postal authority 1970 to effect shipment for the international package.

In one embodiment, in response to collecting the fees for the international shipping label from the shipper, the online postage system 1910 may further send data relating to the transaction associated with the international shipping label to the appropriate postal authorities 1970, wherein the data may be sent to the appropriate postal authorities 1970 on a daily basis, weekly basis, or any other suitable basis. In one embodiment, the data sent to the postal authorities 1970 may relate to funds that have been pre-paid and collected for taxes and duties associated with certain packages designated for delivery to certain foreign countries, and may further relate to specific transactions associated with the packages for which the taxes and duties have been pre-paid and collected. For example, in one embodiment, the online postage system 1910 may receive electronic manifests that describe the specific package transactions using techniques described in further detail in U.S. patent application Ser. No. 11/165,636, filed Jun. 23, 2005, entitled “Tracking Recordation System for Packages,” the disclosure of which is hereby incorporated by reference in its entirety.

As such, in one embodiment, the online postage system 1910 may use the electronic manifests to generate various records linking specific package transactions with corresponding pre-paid taxes and duties, whereby the records may be referenced to determine quantities of funds to be sent to postal authorities 1970 in certain foreign countries. For example, the online postage system 1910 may send the relevant funds to postal authorities 1970 that include the USPS, international postal services, foreign postal services, customs agencies, or any other suitable entity, as will be apparent (e.g., the online postage system may 1910 send the funds to postal authorities 1970 at the USPS, which may then deliver the funds to the appropriate international or foreign postal authorities 1970, or the online postage system 1910 may alternatively send the funds directly to the appropriate international or foreign postal authorities 1970). The present system provides the benefit that the collected funds are sent to the international or foreign authority prior to the foreign authority processing the goods for shipment to the intended recipient. This eliminates the hassle for the foreign authority (postal service, customs agency, etc.) to collect the fees at delivery of the goods to the recipient. Moreover, this eliminates the hassle for the recipient to be present to receive the goods and pay for the fees.

In addition, the online postage system 1910 may send the supporting package transaction data obtained from the electronic manifests to the postal authorities 1960 at the USPS, international postal services, foreign postal services, customs agencies, or other suitable entities, whereby the appropriate postal authorities 1970 may identify the specific packages that have pre-paid taxes and duties (e.g., in response to scanning a customs barcode printed on a shipping label affixed to a particular package that is linked to a particular transaction in which the taxes and duties were pre-paid). Accordingly, when the packages that have pre-paid taxes and duties arrive at a postal authority 1970 such as an International Service Center (ISC), the ISC postal authority 1970 may segregate such packages for expedited dispatch.

Additionally, in one embodiment, in response to collecting the fees for the international shipping label from the shipper, the online postage system 1910 further may send a notification to the recipient of the international package associated with the international shipping label. For example in one embodiment, the shipper may optionally provide an e-mail address or other information that can be used to notify the recipient of the international package in the request provided from the shipper computer 1950 to the online postage system 1910. Accordingly, the online postage system 1910 may send an e-mail or other suitable notification to the recipient to indicate that the postal authority 1970 has initiated shipment of the international package. For example, in one embodiment, the online postage system 1910 may determine whether an induction scan has occurred for the international package using techniques described in further detail in U.S. patent application Ser. No. 11/165,636, which is incorporated by reference above, wherein the notification may be sent to the recipient in response to the induction scan. Furthermore, in one embodiment, the notification sent to the recipient may further indicate that the shipper has pre-paid the taxes and duties for the international package, whereby the package can be delivered even if the recipient is not present to formally receive the package.

The systems and methods described herein may also provide for the management of USPS and other post service discount programs. Certain international subclasses of mail, such as Global Express Mail, offer discount programs for volume mailers. International mail is the only mail the USPS has freedom to negotiate rates on, as domestic rates are locked by a complete Postal Rate Commission process. Currently, the USPS administers the international discount program in an inefficient and expensive way. The USPS discounts range from 5% to 12%, depending upon annual package volume. The USPS administers this process through a permit-based accounting scheme. In addition to the potential for revenue loss at induction, as described above, the discount program requires additional accounting and management by USPS personnel. Discounts are based on estimated volumes, not actual volumes, and the discount schedule can therefore be out of sync with the mailer's actual shipment activity.

The systems and methods described herein provide a mechanism for managing such discount programs on behalf of the USPS. A centralized online postage vendor may collect funds prior to postage consumption by credit card, Automated Clearing House (“ACH”) direct debit, or commercial check, whereby mailers can “draw down” on their account balance as postage labels are printed. A discount program administered in this environment may provide advantages including each package bearing full rate postage for the destination country and weight, no revenue loss occurs at induction because the postage is pre-paid and not generated with a permit-based system, discounts can be applied after the fact to reflect the actual activity of the shipper and not estimated volumes, discounts can be inexpensively applied as “electronic credits” to the mailer's existing postage meter account, and USPS auditors and the US Postal Inspection Service have access to detailed package-by-package accounting for all discount program participants.

Volume mailers often use USPS permit account as a mechanism to pay for international shipments. With such mailers, a permit number and city/state of issue replace the live digital postage indicium. While historically convenient for the mailer, this approach is prone to revenue loss by the USPS. The USPS staff must be careful to make full note of all permit mail inducted. Failure to do so will result in the USPS assuming responsibility for delivering the package without drawing funds from the mailer's permit account. USPS losses due to induction failures of this nature are estimated to be on the order of 1% to 3% of total permit revenue.

Thus, in one embodiment, the systems and methods described herein may provide the mailer with the printing convenience of a permit, while simultaneously assuring the USPS of receiving the associated revenue. By printing live online postage from an active USPS meter account, there may be no need for induction accounting at the Post Office, and therefore no associated revenue loss. Further, the USPS and mailer may save the time and expense of a face-to-face induction process. The completely pre-paid packages can be picked up by a USPS carrier during normal rounds or quickly dropped off at any USPS facility.

USPS shipping labels differ from other carriers' labels in that they represent negotiable US funds. If a hardware or software error causes this print cycle to fail, the associated dollar amount of the label is potentially lost to the mailer. Unless properly addressed, these losses can drive a shipper away from USPS as a carrier into competing carriers such as FedEx or UPS who have a different billing scheme.

The systems and methods described herein provide a refund protocol for domestic mail labels that carry delivery confirmation or other tracking barcodes. The patents and patent applications incorporated by reference above describe techniques by which data stored by the centralized postage cluster in conjunction with USPS delivery scan information can be used to determine whether end-user refund requests are reasonable. International shipping labels have been problematic in this regard because only a very limited subset of USPS International mail is tracked—specifically, the relatively expensive Global Express Mail and Global Express Guaranteed services. Not only are these services expensive, they are offered for only a limited number of foreign countries. In fact, the vast majority of mail originating in the US for delivery in foreign countries is not tracked in any way.

Thus, in one embodiment, the systems and methods described herein may bond a unique customs form identifier to a postage transaction, which may enable an automatic “round stamp” feature for integrated shipping label and custom forms generated using the mailing software. For example, due to security requirements, all international packages weighing over one pound are required to carry a customs form, and furthermore all customs forms must be scanned and “round-stamped” by USPS personnel at acceptance. In particular, the round stamp indicates to downstream mail processing facilities (i.e., the approximately ten USPS International Service Centers located on US soil that manage all foreign outbound mail) that a local Post Office has accepted the package in either a face-to-face transaction, or via a secure protocol where the mailer is identified as a “known-mailer.” Moreover, in addition to the round stamp requirement, all customs forms must further include a certification signature from the mailer to indicate that the declarations in the customs form are correct and that the mail piece does not contain any dangerous, prohibited, or otherwise restricted items. For example, the PS 2976 customs declaration form includes a space for the sender's signature, which certifies that “I, the undersigned, whose name and address are given on the item, certify that the particulars given in this declaration are correct and that this item does not contain any dangerous article or articles prohibited by legislation or by postal or customs regulations.”

To that end, the US Postal Inspection Service has allowed the round stamp and certification signature to be electronically printed on approved integrated shipping label and customs forms if such integrated shipping label and customs forms include an electronic postage indicia. In other words, the round stamp and certification signature can be printed electronically on the approved integrated shipping label and customs forms if the shipping label can be traced back to a particular mailer or individual (e.g., via the electronic postage indicia). Accordingly, in one embodiment, the systems and methods described herein may include using the mailing software to automatically generate a round stamp and a certification signature for any appropriate integrated shipping label and customs form bearing electronic postage indicia.

For example, in one embodiment, the centralized postage-issuing computer system may transmit one or more customs form barcode numbers, which may be generated using the mailing software and scanned upon acceptance at the origin Post Office, via an internal USPS network to a USPS database referred to as “GoldMine,” which is currently located in the Eagan, Minnesota Postal Data Center. As such, the centralized postage-issuing computer system may provide the shipping label and customs form information that is generated using the mailing software to the GoldMine database (e.g., on an hourly basis, daily basis, weekly basis, or other intervals), whereby the GoldMine database may store information including the date and time of the induction scan, the origin ZIP code of the Post Office, the package weight (as confirmed by measurement by USPS staff), the destination country, the mail class, the ISC that will handle the package, and the customs form barcode numbers that can be traced back to particular mailers or individuals, among other things.

Furthermore, in one embodiment, the systems and methods described herein may use the USPS GoldMine database and other similar databases to authenticate refund requests on international shipping labels having an integrated customs form and customs form barcode or other unique identifier. While the USPS Goldmine database is on an internal network, all USPS approved online postage vendors also have access to this network. For example, in one embodiment, the refund procedure 2000 may be performed as illustrated in FIG. 15, wherein a mailer (e.g., a user of the mailing software) may request a refund for a given mailing label with an associated customs form barcode or other unique identifier. The request may be received at the centralized postage system on behalf of the USPS in block 2010, wherein block 2020 may include the postage system querying the USPS Goldmine database to determine whether any induction scans have been undertaken for that label within a predetermined expiration time period (e.g., two weeks). If the postage system determines that no induction scan was recorded in the Goldmine database within and/or after the expiration time period in decision block 2030, the postage system may then grant the refund in block 2040. Furthermore, in one embodiment, the postage system may install various auditing controls to track refund trends for a given mailer or other user to detect when systematic abuse of the refund request process has potentially and/or actually occurred.

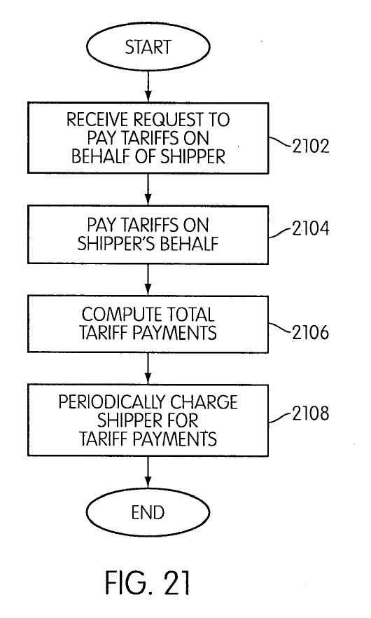

Additionally, in one embodiment, the systems and methods described herein may incorporate a tariff or duties payment procedure 2100 as illustrated in FIG. 21, wherein a centralized postage firm, such as USPS, may pay tariffs or duties on behalf of one or more shippers. For example, a shipper may have already collected a tariff from its customer, or simply has agreed to pay the tariffs on the shipment as part of a purchase transaction. The shipper may use the mailing software described herein to compute the required tariffs. The shipper also may request the centralized postage firm to pay the tariff on its behalf. The request may be in the form of an electronic data message sent from the shipper to a central processor, such as online postage system 1910 (shown in FIG. 19) for example. The central processor may receive a request to pay the tariff on the shipper's behalf in block 2102. The central processor may pay the tariffs on the shipper's behalf in block 2104. The central processor may compute the total amount of tariffs paid over a period of time in block 2106. The central processor may periodically charge the shipper for tariff payments made on the shipper's behalf in block 2108. The centralized processor may support a plurality of shippers who in turn are shipping to a plurality of foreign countries. The centralized processor may accumulate the sum total of tariffs due to all countries and use electronic means to transfer the funds to the one or more authorities of participating countries on a daily, weekly, or monthly basis for example. Each funds transfer may be accompanied by a detailed list of unique customs form identification numbers and originating shipper information. If one or more authorities has already received detailed contents data for a particular customs identification number, an authority's processing system could quickly determine which duties have and have not been paid. It is contemplated that a special marking or symbol may be printed on a shipping label to indicate that tariffs have been prepaid.

As can be appreciated from the above paragraphs, it is further provided a method of determining that duties and taxes on goods in a package have been pre-paid, the package being shipped within an international postal system between an origin country and a destination country. The method includes detecting a postage indicium (e.g., a one dimensional barcode or a 2 dimensional barcode) or mark (e.g., picture, a drawing, text, or symbol, or barcode, or any combination of two or more thereof) on a shipping label associated with the package; and determining whether the indicium or mark indicates to an official (e.g., a customs official) of the destination country that taxes and duties for delivering the package containing the goods to the destination country have been pre-paid. In one embodiment, the method further includes receiving the indicium or mark and comparing the indicium or mark with indicia or marks transmitted from the origin country to the destination country. In one embodiment, the method further includes receiving the indicium comprising a scanned one-dimensional barcode and comparing the scanned one-dimensional barcode with one-dimensional barcodes electronically transmitted from a postage service provider (e.g., Endicia) in the origin country to a customs official in the destination country.

Embodiments of the invention may be made in hardware, firmware, software, or various combinations thereof. The invention may also be implemented as instructions stored on a machine-readable medium, which may be read and executed using one or more processing devices. In one embodiment, the machine-readable medium may include various mechanisms for storing and/or transmitting information in a form that can be read by a machine (e.g., a computing device). For example, a machine-readable storage medium may include read only memory, random access memory, magnetic disk storage media, optical storage media, flash memory devices, and other media for storing information, and a machine-readable transmission media may include forms of propagated signals, including carrier waves, infrared signals, digital signals, and other media for transmitting information. While firmware, software, routines, or instructions may be described in the above disclosure in terms of specific exemplary aspects and embodiments performing certain actions, it will be apparent that such descriptions are merely for the sake of convenience and that such actions in fact result from computing devices, processing devices, processors, controllers, or other devices or machines executing the firmware, software, routines, or instructions.

Furthermore, aspects and embodiments may be described in the above disclosure as including particular features, structures, or characteristics, but it will be apparent that every aspect or embodiment may or may not necessarily include the particular features, structures, or characteristics. Further, where particular features, structures, or characteristics have been described in connection with a specific aspect or embodiment, it will be understood that such features, structures, or characteristics may be included with other aspects or embodiments, whether or not explicitly described. Thus, various changes and modifications may be made to the preceding disclosure without departing from the scope or spirit of the invention, and the specification and drawings should therefore be regarded as exemplary only, with the scope of the invention determined solely by the appended claims.

What is claimed is:

1. A computer-usable medium communicatively coupled to an online postage system configured to manage landed cost and harmonization for international packages shipped within an international postal system, the computer-usable medium having a sequence of instructions which, when executed on a processor, cause the processor to:
receive a request for an international shipping label, wherein the request includes at least a description of contents for a package onto which the international shipping label is to be placed and a destination country where the package is to be delivered;
generate a unique self-validating postage indicium or mark in response to the request, wherein the unique self-validating postage indicium or mark indicates that landed costs for delivering the package containing the contents to the destination country have been pre-paid; and
enable printing of the international shipping label having the unique self-validating postage indicium printed thereon, wherein the international shipping label further has a customs declaration form that includes the description of the contents of the package onto which the international shipping label is to be placed.

2. The computer-usable medium of claim 1, wherein the international shipping label further has a unique customs form number printed thereon, wherein the customs form number is linked to the unique self-validating postage indicium.

3. The computer-usable medium of claim 1, wherein the unique self-validating postage indicium includes a two-dimensional barcode.

4. The computer-usable medium of claim 1, wherein the sequence of instructions further cause the processor to:
query a database containing a harmonization table that provides an international classification system, wherein the database is queried to obtain one or more harmonization codes corresponding to the description of the contents; and
calculate estimated taxes and duties required to deliver the package containing the contents corresponding to the harmonization codes to the destination country, wherein the pre-paid landed costs include at least the estimated taxes and duties.

5. The computer-usable medium of claim 4, wherein the request further includes a valuation of the contents for the package and an origin country from which the package is to be shipped.

6. The computer-usable medium of claim 5, wherein the estimated taxes and duties are calculated as a function of the destination country, the harmonization codes corresponding to the description of the contents, the valuation of the contents, and the origin country.

7. The computer-usable medium of claim 5, wherein the sequence of instructions further cause the processor to track the description of the contents and the valuation of the contents provided in the request to detect potential or actual occurrences of fraud or abuse.

8. The computer-usable medium of claim 4, wherein the sequence of instructions further cause the processor to query the database containing a tariff schedule for the destination country, wherein the database is queried to map the one or more harmonization codes to the tariff schedule for the destination country.

9. The computer-usable medium of claim 8, wherein the estimated taxes and duties are calculated based on the mapping of the harmonization codes to the tariff schedule for the destination country.

10. The computer-usable medium of claim 4, wherein the sequence of instructions further cause the processor to transmit harmonization codes, descriptions of contents, and/or tracking numbers of particular packages to one or more authorities within the international postal system prior to the arrival of the particular packages at the one or more authorities.

11. The computer-usable medium of claim 1, wherein the sequence of instructions further cause the processor to collect fees for the international shipping label, wherein the collected fees include at least the pre-paid landed costs for delivering the package containing the contents to the destination country.

12. The computer-usable medium of claim 11, wherein the sequence of instructions further cause the processor to:
send the fees collected for the pre-paid landed costs to one or more authorities within the international postal system; and
send a transaction record associated with the package to the one or more authorities within the international postal system, wherein the transaction record links the unique self-validating postage indicium to the international shipping label to be placed on the package.

13. The computer-usable medium of claim 11, wherein the collected fees further include one or more of a surcharge or service fee for the online postage system.

14. The computer-usable medium of claim 1, wherein the sequence of instructions further cause the processor to require that the request includes an acknowledgement to pay additional funds to the online postage system if actual costs for delivering the package to the destination country exceed the pre-paid landed costs.

15. The computer-usable medium of claim 1, wherein the sequence of instructions further cause the processor to send a notification to a recipient of the package onto which the international shipping label is to be placed.

16. The computer-usable medium of claim 15, wherein the notification indicates that the package has been accepted for shipment within the international postal system or that the landed costs for delivering the package have been pre-paid.

17. The computer-usable medium of claim 1, wherein the international shipping label further has a round stamp and a certification signature printed thereon.

18. The computer-usable medium of claim 1, wherein the sequence of instructions further cause the processor to:
receive a request to pay one or more tariffs on behalf of one or more shippers;
pay one or more tariffs on behalf of the one or more shippers;
compute a total amount of tariffs paid on behalf of the one or more shipper; and
charge the one or more shippers for tariff payments made on behalf of the one or more shippers.

19. An online postage system configured to manage landed cost and harmonization for international packages shipped within an international postal system, comprising:
a postage-issuing computer system configured to communicate with a user computer, wherein the postage-issuing computer system is further configured to:
receive a request for an international shipping label from the user computer, wherein the request includes at least a description of contents for a package onto which the international shipping label is to be placed and a destination country where the package is to be delivered;
generate a unique self-validating postage indicium in response to the request, wherein the unique self-validating postage indicium indicates that landed costs for delivering the package containing the contents to the destination country have been pre-paid; and
enable printing of the international shipping label having the unique self-validating postage indicium printed thereon, wherein the international shipping label further has a customs declaration form that includes the description of the contents of the package onto which the international shipping label is to be placed.

20. The system of claim 19, wherein the international shipping label further has a unique customs form number printed thereon, wherein the customs form number is linked to the unique self-validating postage indicium.

21. The system of claim 19, wherein the unique self-validating postage indicium includes a two-dimensional barcode.

22. The system of claim 19, wherein the postage-issuing computer system is further configured to:
query a database containing a harmonization table that provides an international classification system, wherein the database is queried to obtain one or more harmonization codes corresponding to the description of the contents; and
calculate estimated taxes and duties required to deliver the package containing the contents corresponding to the harmonization codes to the destination country, wherein the pre-paid landed costs include at least the estimated taxes and duties.

23. The system of claim 22, wherein the request further includes a valuation of the contents for the package and an origin country from which the package is to be shipped.

24. The system of claim 23, wherein the estimated taxes and duties are calculated as a function of the destination country, the harmonization codes corresponding to the description of the contents, the valuation of the contents, and the origin country.

25. The system of claim 23, wherein the postage-issuing computer system is further configured to track the description of the contents and the valuation of the contents provided in the request to detect potential or actual occurrences of fraud or abuse.

26. The system of claim 22, wherein the postage-issuing computer system is further configured to query the database containing a tariff schedule for the destination country, wherein the database is queried to map the one or more harmonization codes to the tariff schedule for the destination country.

27. The system of claim 26, wherein the estimated taxes and duties are calculated based on the mapping of the harmonization codes to the tariff schedule for the destination country.

28. The computer-usable medium of claim 22, wherein the sequence of instructions further cause the processor to transmit harmonization codes, descriptions of contents, and/or tracking numbers of particular packages to one or more authorities within the international postal system prior to the arrival of the particular packages at the one or more authorities.

29. The system of claim 19, wherein the postage-issuing computer system is further configured to collect fees for the international shipping label, wherein the collected fees include at least the pre-paid landed costs for delivering the package containing the contents to the destination country.

30. The system of claim 29, wherein the postage-issuing computer system is further configured to:
send the fees collected for the pre-paid landed costs to one or more authorities within the international postal system; and
send a transaction record associated with the package to the one or more authorities within the international postal system, wherein the transaction record links the unique self-validating postage indicium to the international shipping label to be placed on the package.

31. The system of claim 29, wherein the collected fees further include one or more of a surcharge or service fee for the online postage system.

32. The system of claim 19, wherein the postage-issuing computer system is further configured to require that the request includes an acknowledgement to pay additional funds to the online postage system if actual costs for delivering the package to the destination country exceed the pre-paid landed costs.

33. The system of claim 19, wherein the postage-issuing computer system is further configured to send a notification to a recipient of the package onto which the international shipping label is to be placed.

34. The system of claim 33, wherein the notification indicates that the package has been accepted for shipment within the international postal system or that the landed costs for delivering the package have been pre-paid.

35. The system of claim 19, wherein the international shipping label further has a round stamp and a certification signature printed thereon.

36. The system of claim 19, wherein the postage-issuing computer system is further configured to:
receive a request to pay one or more tariffs on behalf of one or more shippers;
pay one or more tariffs on behalf of the one or more shippers;
compute a total amount of tariffs paid on behalf of the one or more shippers; and
charge the one or more shippers for tariff payments made on behalf of the one or more shippers.

37. A method for managing landed cost and harmonization for international packages shipped within an international postal system, comprising:
receiving a request for an international shipping label, wherein the request is received at an online postage system, and wherein the request includes at least a description of contents for a package onto which the international shipping label is to be placed and a destination country where the package is to be delivered;
generating a unique self-validating postage indicium at the online postage system in response to the request, wherein the unique self-validating postage indicium indicates that landed costs for delivering the package containing the contents to the destination country have been pre-paid; and
enabling printing of the international shipping label having the unique self-validating postage indicium printed thereon, wherein the international shipping label further has a customs declaration form that includes the description of the contents of the package onto which the international shipping label is to be placed.

38. The method of claim 37, wherein the international shipping label further has a unique customs form number printed thereon, wherein the customs form number is linked to the unique self-validating postage indicium.

39. The method of claim 37, wherein the unique self-validating postage indicium includes a two-dimensional barcode.

40. The method of claim 37, further comprising:
querying a database coupled to the online postage system containing a harmonization table that provides an international classification system, wherein the online postage system queries the database to obtain one or more harmonization codes corresponding to the description of the contents; and
calculating estimated taxes and duties required to deliver the package containing the contents corresponding to the harmonization codes to the destination country, wherein the pre-paid landed costs include at least the estimated taxes and duties.

41. The method of claim 40, wherein the request further includes a valuation of the contents for the package and an origin country from which the package is to be shipped.

42. The method of claim 41, wherein the online postage system calculates the estimated taxes and duties as a function of the destination country, the harmonization codes corresponding to the description of the contents, the valuation of the contents, and the origin country.

43. The method of claim 41, further comprising tracking the description of the contents and the valuation of the contents provided in the request at the online postage system to detect potential or actual occurrences of fraud or abuse.

44. The method of claim 40, further comprising querying the database containing a tariff schedule for the destination country, wherein the online postage system queries the database to map the one or more harmonization codes to the tariff schedule for the destination country.

45. The method of claim 44, wherein the estimated taxes and duties are calculated based on the mapping of the harmonization codes to the tariff schedule for the destination country.

46. The computer-usable medium of claim 40, wherein the sequence of instructions further cause the processor to transmit harmonization codes, descriptions of contents, and/or tracking numbers of particular packages to one or more authorities within the international postal system prior to the arrival of the particular packages at the one or more authorities.

47. The method of claim 37, further comprising collecting fees at the online postage system for the international shipping label, wherein the collected fees include at least the pre-paid landed costs for delivering the package containing the contents to the destination country.

48. The method of claim 47, further comprising:
sending the fees collected for the pre-paid landed costs from the online postage system to one or more authorities within the international postal system; and
sending a transaction record associated with the package from the online postage system to the one or more authorities within the international postal system, wherein the transaction record links the unique self-validating postage indicium to the international shipping label to be placed on the package.

49. The method of claim 47, wherein the collected fees further include one or more of a surcharge or service fee for the online postage system.

50. The method of claim 37, further comprising requiring that the request includes an acknowledgement to pay additional funds to the online postage system if actual costs for delivering the package to the destination country exceed the pre-paid landed costs.

51. The method of claim 37, further comprising sending a notification from the online postage system to a recipient of the package onto which the international shipping label is to be placed.

52. The method of claim 51, wherein the notification indicates that the package has been accepted for shipment within the international postal system or that the landed costs for delivering the package have been pre-paid.

53. The method of claim 37, wherein the international shipping label further has a round stamp and a certification signature printed thereon.

54. The method of claim 37, further comprising:
receiving a request to pay one or more tariffs on behalf of one or more shippers;
paying one or more tariffs on behalf of the one or more shippers;
computing a total amount tariffs paid on behalf of the one or more shippers; and
charging the one or more shippers for tariff payments on behalf of the one or more shippers.

55. A computer-usable medium communicatively coupled to an online postage system configured to manage landed cost and harmonization for international packages shipped within an international postal system, the computer-usable medium having a sequence of instructions which, when executed on a processor, cause the processor to:
receive a request for an international shipping label, wherein the request includes at least a description of contents for a package onto which the international shipping label is to be placed and a destination country where the package is to be delivered;
generate a postage indicium, mark or symbol in response to the request, wherein the postage indicium, mark or symbol indicates to a customs official of destination country that landed costs for delivering the package containing the contents to the destination country have been pre-paid.

56. The computer-usable medium of claim 55, wherein the indicium is a barcode tracking indicium for tracking the package.

57. The computer-usable medium of claim 55, wherein the indicium is a two-dimensional barcode indicium containing information about the package including origin ZIP code, postage amount, or any combination of two or more thereof.

58. The computer-usable medium of claim 55, wherein the mark is a drawing, a picture, or a barcode, or any combination of two or more thereof.

59. The computer-usable medium of claim 55, wherein the landed costs comprise taxes and duties.

60. A method of determining that duties and taxes on goods in a package have been pre-paid, the package being shipped within an international postal system between an origin country and a destination country, the method comprising:
detecting a postage indicium or mark on a shipping label associated with the package; and
determining whether the indicium or mark indicates to a customs official of the destination country that taxes and duties for delivering the package containing the goods to the destination country have been pre-paid.

61. The method of claim 60, further comprising receiving the indicium or mark and comparing the indicium or mark with indicia or marks transmitted from the origin country to the destination country.

62. The method of claim 60, further comprising receiving the indicium comprising a scanned one-dimensional barcode and comparing the scanned one-dimensional barcode with one-dimensional barcodes electronically transmitted from a postage service provider in the origin country to an official in the destination country.
